(19) United States
(12) Patent Application Publication
(10) Pub. No.: US 2011/0310099 A1
(43) Pub. Date: Dec. 22, 2011

(54) THREE-DIMENSIONAL IMAGE PROCESSING APPARATUS AND METHOD OF CONTROLLING THE SAME

(75) Inventors: Akifumi YAMANA, Hyogo (JP); Atsushi NISHIYAMA, Osaka (JP); Nobutaka KITAJIMA, Osaka (JP); Tsutomu HASHIMOTO, Osaka (JP)

(73) Assignee: PANASONIC CORPORATION, Osaka (JP)

(21) Appl. No.: 13/218,970

(22) Filed: Aug. 26, 2011

Related U.S. Application Data
(63) Continuation of application No. PCT/JP2010/005035, filed on Aug. 11, 2010.

(30) Foreign Application Priority Data
Sep. 25, 2009 (JP) 2009-221566

(51) Int. Cl. G06T 15/00

(52) U.S. Cl. 345/419

(57) ABSTRACT

A 3D image processing apparatus which generates a left-eye image signal and a right-eye image signal for stereoscopic vision, including: a blend ratio determination unit which determines, for each of a plurality of objects which are displayed in layers, a blend ratio that is used in synthesizing images, at each pixel position of the left-eye image signal and the right-eye image signal, so that the blend ratio increases as an offset that is an amount of shift in position between a left-eye image and a right-eye image of the object increases; and a synthesis unit which synthesizes, based on the blend ratio determined by the blend ratio determination unit, pixel values of the objects at each pixel position of the left-eye image signal and the right-eye image signal, to generate the left-eye image signal and the right-eye image signal.

### CROSS REFERENCE TO RELATED APPLICATION

This is a continuation application of PCT application No. PCT/JP2010/005035 filed on Aug. 11, 2010, designating the United States of America.

### BACKGROUND OF THE INVENTION

(1) Field of the Invention

The present invention relates to three-dimensional (3D) image processing apparatuses and methods of controlling the same, and particularly to a 3D image processing apparatus and a method of controlling the same, which generate image signals for displaying an object such as a thumbnail or a subtitle at a depth which can be changed with respect to another object.

(2) Description of the Related Art

Conventionally, there have been known two-dimensional (2D) image processing apparatuses which generate image signals in which a plurality of objects such as photo thumbnails are superimposed on one another. FIG. 30 is a block diagram showing an example of a structure of a conventional 2D image processing apparatus. A 2D image processing apparatus 300 includes a decoder 310, a first memory 321, a second memory 322, a third memory 323, display position control units 331 to 333, and a synthesis unit 350.

The decoder 310 decodes coded data generated by decoding image signals of the first to third objects, to generate image signals of the first to third objects. The first memory 321 to the third memory 323 stores the respective image signals of the first to third objects generated by the decoder 310. The display position control units 331 to 333 determine respective display positions of the first to third objects stored in the first memory 321 to the third memory 323. The synthesis unit 350 generates an image signal in which the first to third objects are synthesized whose display positions have been determined respectively by the display position control units 331 to 333, and displays the generated image signal.

For example, assume that the first to third objects are thumbnails A to C, respectively, and as shown in (a) in FIG. 31, the thumbnail B is displayed over the thumbnails A and C. In this case, selection of the thumbnail A according to a user instruction input or the like will cause the display position control unit 331 to determine the display position of the thumbnail A so that the display size of the selected thumbnail A is largest as shown in (b) in FIG. 31. Furthermore, the synthesis unit 350 determines a blend ratio of the thumbnails A, B, and C in each pixel so that the thumbnail A is displayed over the thumbnails C and B. Subsequently, the synthesis unit 350 synthesizes, in each pixel, the thumbnails according to the blend ratio. For example, in a pixel at which the thumbnails A, B, and C overlap with one another, the blend ratio is determined to decrease in the following order: the thumbnail A, the thumbnail B, and the thumbnail C. As a result, an image signal with which the thumbnail A is displayed at the front most position is generated.

In the meantime, there have been known 3D image display apparatuses which display 3D images that are 2D images which convey a stereoscopic perception to viewers (for example, see Patent Literature 1: Japanese Unexamined Patent Application Publication No. 2009-124768). Moreover, in recent years, home televisions having a function of displaying such 3D images have been increasingly implemented.

This 3D image display apparatus displays the images which convey a stereoscopic perception to viewers, by displaying a right-eye image and a left-eye image which have a parallax therebetween. For example, the 3D image display apparatus displays the right-eye image and the left-eye image alternately for each frame.

### SUMMARY OF THE INVENTION

However, the application of synthesis technique of the conventional 2D image processing apparatus 300 to conventional 3D image display apparatuses causes a problem of displaying images which bring a feeling of strangeness to viewers.

This problem is described with reference to FIG. 32. Assume that thumbnails are displayed so that a thumbnail B is superimposed on thumbnails A and C as shown in (a) in FIG. 32. In this case, in order to display each of the thumbnails in three dimensions, a display control has been performed on each of the thumbnails in advance such that the left-eye image and the right-eye image have a parallax therebetween. In this figure, each of the thumbnails is shown with a shadow of hatch lines so as to give a stereoscopic perception, and as the shadow is wider, the parallax is greater. This applies also to the other figures.

In this state, selection of the thumbnail A results in determining the display positions such that the display size of the thumbnail A becomes largest as in the conventional techniques, and determining the blend ratio such that the thumbnail A is displayed at the front most position. By so doing, an image shown in (b) in FIG. 32 is displayed. In this image, at a pixel position where the thumbnails A and B overlap, the blend ratio of the thumbnail A is greater than the blend ratio of the thumbnail B, which causes the image of the thumbnail A to be emphasized more than the image of the thumbnail B when displayed. On the other hand, the parallax of the thumbnail A is smaller than the parallax of the thumbnail B. Accordingly, when displayed, the thumbnail B which is supposed to be displayed behind the thumbnail A will stand out in front thereof. Thus, an image which brings a feeling of strangeness to viewers is displayed.

The present invention has been devised in order to solve the above-described problem, and an object of the present invention is to provide a 3D image processing apparatus and a method of controlling the same, which can generate image signals of images which bring no feeling of strangeness to viewers.

In order to achieve the above object, a 3D image processing apparatus according to an aspect of the present invention is a 3D image processing apparatus which generates image signals of multiple views for stereoscopic vision, the 3D image processing apparatus including: a blend ratio determination unit configured to determine, for each of a plurality of objects which are displayed in layers, a blend ratio that is used in synthesizing images, at each pixel position of the image signals of the views, based on an offset that is an amount of shift in position between the image signals of the views of the object; and a synthesis unit configured to synthesize, based on the blend ratio determined by the blend ratio determination unit, pixel values of the objects at the each pixel position of the image signals of the views, to generate the image signals of the views.

With this structure, the blend ratio is determined based on the offset. It is therefore possible to generate image signals of images which bring no feeling of strangeness to viewers.

Preferably, the image signals of the multiple views include a left-eye image signal and a right-eye image signal for stereoscopic vision, the blend ratio determination unit is configured to determine, for each of the objects which are displayed in layers, the blend ratio that is used in synthesizing the images, at each pixel position of the left-eye image signal and the right-eye image signal, based on an offset that is an amount of shift in position between a left-eye image and a right-eye image of the object, and the synthesis unit is configured to synthesize, based on the blend ratio determined by the blend ratio determination unit, the pixel values of the objects at the each pixel position of the left-eye image signal and the right-eye image signal, to generate the left-eye image signal and the right-eye image signal.

More preferably, the blend ratio determination unit is configured to determine, for each of the objects which are displayed in layers, the blend ratio that is used in synthesizing the images, at the each pixel position of the left-eye image signal and the right-eye image signal, so that the blend ratio increases as the offset that is the amount of shift in position between the left-eye image and the right-eye image of the object increases.

With this structure, the offset and the blend ratio of the object are linked to each other, and when the offset is large, then control is performed such that the blend ratio becomes larger. It is therefore possible to generate image signals of images which bring no feeling of strangeness to viewers.

Preferably, the blend ratio determination unit is configured to determine the blend ratio at the each pixel position of the left-eye image signal and the right-eye image signal so that, among the objects which are displayed in layers, an object whose offset is largest has a blend ratio of 100 percent and an other object has a blend ratio of 0 percent.

With this structure, control is performed such that only the object having the largest offset is displayed. It is therefore possible to generate image signals of images which bring no feeling of strangeness to viewers.

More preferably, the above 3D image processing apparatus further includes an offset control unit configured to determine the offset of each of the objects based on a depth of the object in 3D presentation, and the blend ratio determination unit is configured to determine the blend ratio based on the offset determined by the offset control unit.

More preferably, the offset control unit is configured to determine the offset so that, among the objects, an object displayed forward in 3D presentation has a larger offset.

With this structure, the offset and the blend ratio of each of the plurality of objects can be determined based on the relation of relative positions of the objects.

More preferably, the offset control unit includes a selection input receiving unit configured to receive a selection input of the object, and is configured to determine the offset of the object received by the selection input receiving unit, so that the offset of the received object is largest.

With this structure, the selected object can be displayed at the front most position.

More preferably, the offset control unit is configured to increase the offset of a first object in stages when the first object transits from back to front with respect to a second object in 3D presentation.

With this structure, viewers can be provided with a visual effect to have the selected object gradually displayed to the front.

More preferably, the above 3D image processing apparatus further includes a limiting unit configured to limit a display region of the object so that the display region of the object is within a displayable region of the left-eye image signal or the right-eye image signal, when the display region of the object is located outside the displayable region.

More preferably, the limiting unit is configured to, when the display region of the object is located outside the displayable region of one of the left-eye image signal and the right-eye image signal, (i) move the display region of the object on the one image signal so that the display region of the object is within the displayable region of the one image signal, and (ii) move, on the other image signal, the display region of the object in a direction opposite to a direction in which the display region of the object is moved on the one image signal, by a travel distance equal to a travel distance by which the display region of the object is moved on the one image signal.

With this structure, the parallax between the left-eye image signal and the right-eye image signal becomes smaller, which may disrupt the relation of relative positions of the objects, but allows the entire objects to be displayed and makes it possible to generate image signals of images which bring no feeling of strangeness to viewers when the images are displayed in 3D.

Furthermore, the limiting unit is configured to delete, from the left-eye image signal and the right-eye image signal, a region of the object located outside the displayable region of the left-eye image signal or the right-eye image signal, when the display region of the object is located outside the displayable region.

With this structure, a part of the thumbnails is deleted when displayed in 3D, but the thumbnails can be displayed with the relation of relative positions of the thumbnails maintained, and it is therefore possible to generate image signals of images which bring no feeling of strangeness to viewers when the images are displayed in 3D.

More preferably, the objects include a plurality of video objects each having the offset, and when the offset of one of the video objects is larger than the offset of the object which is displayed forward of the video object in 3D presentation, the offset of the video object is updated to the offset of the object which is displayed forward.

With this structure, a part of the region of a rear position object will be no longer displayed forward of a front position object, and it is therefore possible to generate image signals of images which bring no feeling of strangeness to viewers.

It is to be noted that the present invention may be implemented not only as a 3D image processing apparatus which includes such characteristic processing units, but also as a method of controlling the 3D image processing apparatus, which method includes steps represented by the characteristic processing units included in the 3D image processing apparatus. Furthermore, the present invention may be implemented also as a program which causes a computer to execute the characteristic steps included in the method of controlling the 3D image processing apparatus. In addition, it goes without saying that such program may be distributed via a recording medium such as a Compact Disc-Read Only Memory (CD-ROM) and a communication network such as the Internet.

Furthermore, the present invention may be implemented as a semiconductor integrated circuit (LSI) which implements part or all of the functions of the 3D image processing apparatus, and implemented as a 3D image display apparatus such as a digital television which includes the 3D image processing apparatus, and implemented as a 3D image display system which includes the 3D image display apparatus.

The present invention can provide a 3D image processing apparatus capable of generating image signals of images which bring no feeling of strangeness to viewers, and also provide a method of controlling the same.

Further Information about Technical Background to This Application

The disclosure of Japanese Patent Application No. 2009-221566 filed on Sep. 25, 2009 including specification, drawings and claims is incorporated herein by reference in its entirety.

The disclosure of PCT application No. PCT/JP2010/005035 filed on Aug. 11, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a 3D image display system according to the first embodiment of the present invention;

FIG. 2A shows an example of output 3D image data including image data of left-eye images and right-eye images;

FIG. 2B shows another example of the output 3D image data including the image data of the left-eye images and the right-eye images;

FIG. 3 shows an example of the left-eye image and the right-eye image;

FIG. 4 is a block diagram showing a structure of a 3D image processing apparatus according to the first embodiment of the present invention;

FIG. 5 is a block diagram showing a structure of an offset control unit;

FIG. 6 is a block diagram showing a more detailed structure of a blend ratio determination unit;

FIG. 7 shows transition of offsets and display positions of thumbnails;

FIG. 8 is a timing chart of a process which the offset control unit executes at the time of transition shown in FIG. 7;

FIG. 9 shows transition of the offsets and the display positions of the thumbnails;

FIG. 10 is a timing chart of a process which the offset control unit executes at the time of transition shown in FIG. 9;

FIG. 11 shows transition of the offsets and the display positions of the thumbnails;

FIG. 12 is a timing chart of a process which the offset control unit executes at the time of transition shown in FIG. 11;

FIG. 13 shows an example of images displayed on a display panel;

FIG. 14 is a timing chart of a process which a blend ratio control unit executes;

FIG. 15 is a timing chart of a process which an L blend ratio generation unit of an L/R blend ratio synthesis unit executes;

FIG. 16 shows transition of the offsets and the display positions of the thumbnails;

FIG. 17 is a block diagram showing a structure of a blend ratio determination unit according to a variation of the first embodiment of the present invention;

FIG. 18 is a timing chart of a process which a relative position information generation unit executes;

FIG. 19 is a block diagram showing a structure of a 3D image processing apparatus according to the second embodiment of the present invention;

FIG. 20 shows a change in display position of a thumbnail displayed in 3D;

FIG. 21 is a timing chart of a process which an L display position limiting control unit and an R display position limiting control unit execute;

FIG. 22 is a timing chart of a process which an offset subtraction control unit executes;

FIG. 23 shows a change in display position of the thumbnail displayed in 3D;

FIG. 24 is a timing chart of a process which an L display position limiting control unit and an R display position limiting control unit according to a variation of the second embodiment of the present invention execute;

FIG. 25 is a block diagram showing a structure of a 3D image display system according to the third embodiment of the present invention;

FIG. 26 is a block diagram showing a structure of a 3D image processing apparatus according to the third embodiment of the present invention;

FIGS. 27A and 27B each show an example of the output 3D image data in which a graphic offset of a subtitle is greater than a video offset;

FIGS. 28A and 28B each show a region where a graphic offset of subtitle data is smaller than a video offset;

FIGS. 29A and 29B each shows an example of the output 3D image data in which a graphic offset of the subtitle is smaller than a video offset;

FIG. 30 is a block diagram showing an example of a structure of a conventional 2D image processing apparatus;

FIG. 31 shows transition of display positions of thumbnails; and

FIG. 32 explains a problem of a conventional technique.

### DESCRIPTION OF THE PREFERRED EMBODIMENT(S)

Embodiments of a 3D image processing apparatus according to the present invention are described in detail below with reference to the drawings.

### First Embodiment

A 3D image processing apparatus according to the first embodiment of the present invention generates image signals for stereoscopic vision, which bring no feeling of strangeness to viewers, in the case where a plurality of objects represented by thumbnails of photographs are displayed over one another.

First, a structure of a 3D image display system including the 3D image processing apparatus according to the first embodiment of the present invention is described.

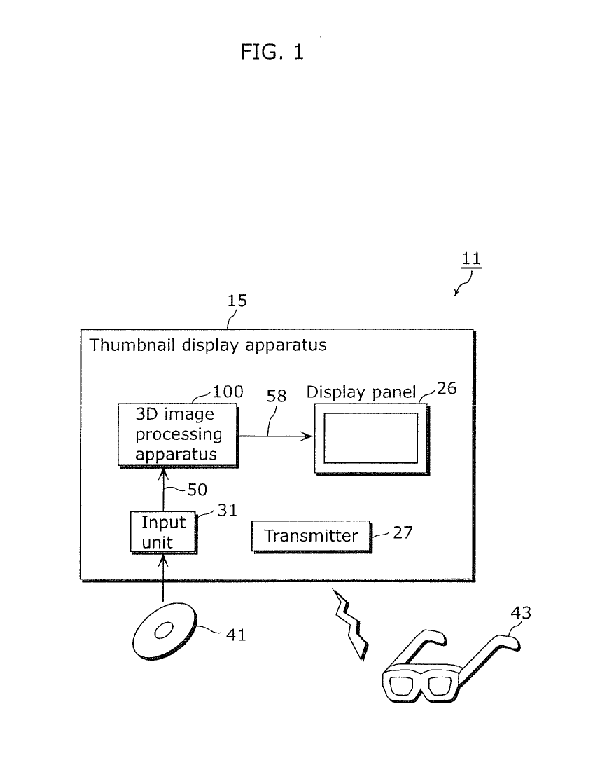

FIG. 1 is a block diagram showing the structure of the 3D image display system according to the first embodiment of the present invention.

A 3D image display system 11 shown in FIG. 1 includes a thumbnail display apparatus 15 and shutter glasses 43.

The thumbnail display apparatus 15 generates a thumbnail from 2D image data or 3D image data such as photograph data recorded on an optical disc 41 such as a blu-ray disc (BD), and converts the thumbnail into a format in which the thumbnail can be displayed in 3D, and then displays 3D image data resulting from the conversion.

The thumbnail display apparatus 15 includes an input unit 31, a 3D image processing apparatus 100, a display panel 26, and a transmitter 27.

The input unit 31 obtains coded 2D image data 50 recorded on the optical disc 41. The coded 2D image data 50 is data generated by coding the photograph data. It is to be noted that the coded data is not limited to the photograph data and may be other data such as video data.

The 3D image processing apparatus 100 generates output 3D image data 58 by converting the thumbnail of the photograph data included in the coded 2D image data 50 obtained by the input unit 31, into a format in which the thumbnail can be displayed in 3D, and then outputs the output 3D image data 58.

The display panel 26 displays the output 3D image data 58 output by the 3D image processing apparatus 100.

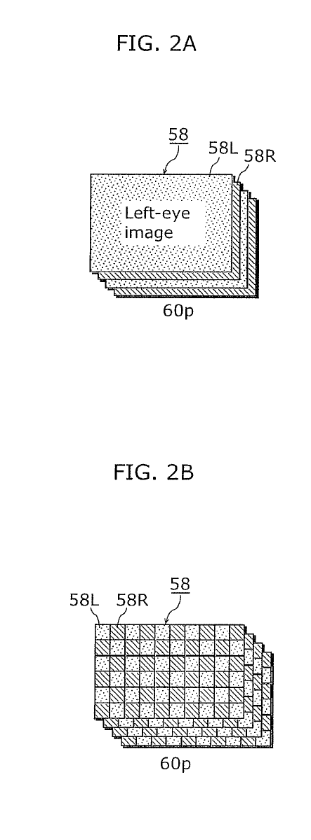

As shown in FIG. 2A, the output 3D image data 58 includes image data of a left-eye image 58L and a right-eye image 58R. Hereinafter, the left-eye image 58L may indicate the image data of the left-eye image 58L as appropriate. The same applies to the right-eye image 58R. The 3D image processing apparatus 100 generates the output 3D image data 58 in which a frame including the left-eye image 58L only and a frame including the right-eye image 58R only are alternately disposed. The output 3D image data 58 is an image data of 60p (in progressive format at a frame rate of 60 frames per second (fps)), for example.

The transmitter 27 controls the shutter glasses 43 using wireless communications.

The shutter glasses 43 are, for example, liquid crystal shutter glasses worn by a viewer, and include a left-eye liquid crystal shutter and a right-eye liquid crystal shutter. The transmitter 27 controls opening and closing of the left-eye liquid crystal shutter and the right-eye liquid crystal shutter with the same timing of displaying the left-eye image 58L and the right-eye image 58R. Specifically, the transmitter 27 opens the left-eye liquid crystal shutter of the shutter glasses 43 and closes the right-eye liquid crystal shutter thereof while the left-eye image 58L is displayed. Furthermore, the transmitter 27 closes the left-eye liquid crystal shutter of the shutter glasses 43 and opens the right-eye liquid crystal shutter thereof while the right-eye image 58R is displayed. By such controls on the display timing and the opening and closing timing of the shutters, the left-eye image 58L and the right-eye image 58R selectively and respectively enter the left eye and the right eye of the viewer.

It is to be noted that the method of selectively presenting the left-eye image 58L and the right-eye image 58R respectively to the left eye and the right eye of the viewer is not limited to the method described above, and a method other than the above may be used.

For example, as shown in FIG. 2B, the left-eye images 58L and the right-eye images 58R may be arranged in a checkered pattern within each frame in the output 3D image data 58. In this case, the display panel 26 includes a left-eye polarizing film formed on a left-eye pixel and a right-eye polarizing film formed on a right-eye pixel so that the left-eye image 58L and the right-eye image 58R are subject to different polarizations (linear polarization, circular polarization, or the like). The shutter glasses 43 can be replaced by polarized glasses having a left-eye polarizing filter and a right-eye polarizing filter which correspond to the above respective polarizations, so that the left-eye image 58L and the right-eye image 58R enter the left eye and the right eye, respectively, of the viewer.

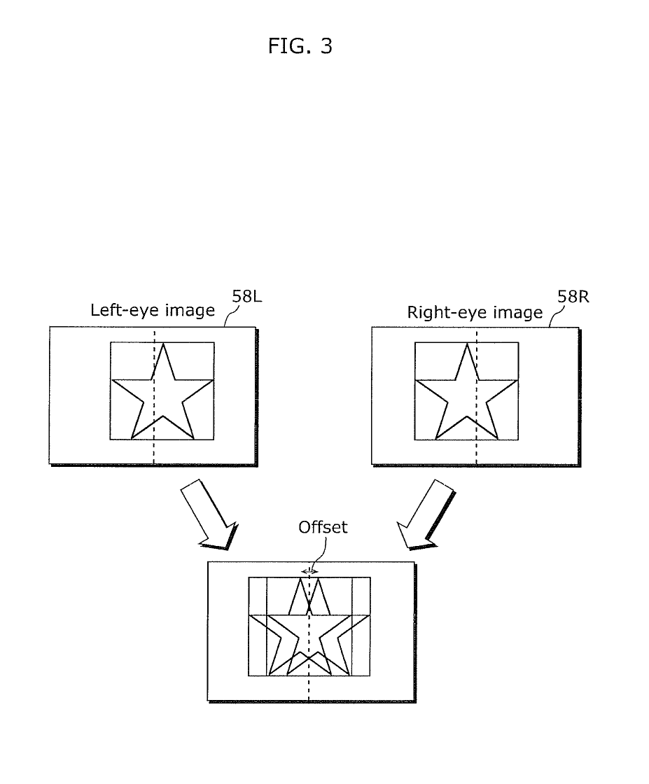

FIG. 3 shows an example of the left-eye image 58L and the right-eye image 58R.

As shown in FIG. 3, objects included in the left-eye image 58L and the right-eye image 58R have a parallax which depends on a distance from an image capturing position to the objects. This parallax is hereinafter referred to as “offset”. When displayed in 3D, the object with a larger offset is displayed at a more forward position (that is a position closer to a viewer) while the object with a smaller offset is displayed at a more rearward position (that is a position farther away from a viewer).

Next, a structure of the 3D image processing apparatus 100 is described.

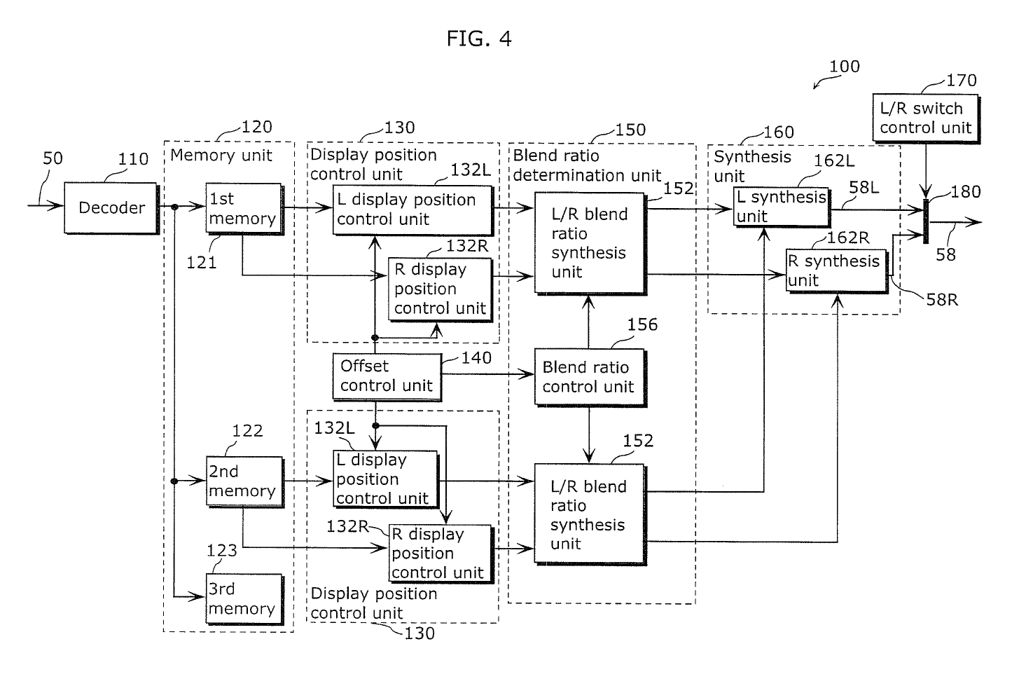

FIG. 4 is a block diagram showing the structure of the 3D image processing apparatus 100.

As shown in FIG. 4, the 3D image processing apparatus 100 includes a decoder 110, a memory unit 120, a display position control unit 130, an offset control unit 140, a blend ratio determination unit 150, a synthesis unit 160, an L/R switch control unit 170, and a selector 180.

The decoder 110 decodes the coded 2D image data 50 obtained by the input unit 31, to generate a plurality of photograph data.

The memory unit 120 stores the plurality of photograph data generated by the decoder 110.

The display position control unit 130 is provided for each of the photograph data, and determines a display position of the photograph data.

The offset control unit 140 determines an offset of each of the photograph data based on a relation of relative positions of the plurality of photograph data. The relation of relative positions indicates a positional relation of a plurality of photographs which are displayed over one another.

The blend ratio determination unit 150 determines the blend ratio of each of the photograph data based on the display position of a corresponding one of the photograph data determined by the display position control unit 130, and the offset of a corresponding one of the photograph data determined by the offset control unit 140.

The synthesis unit 160 synthesizes pixels values of the plurality of photograph data based on the blend ratio determined by the blend ratio determination unit 150, to generate the left-eye image 58L and the right-eye image 58R, and then outputs the generated left-eye image 58L and right-eye image 58R.

The selector 180 selects one of the left-eye image 58L and the right-eye image 58R which is outputted by the synthesis unit 160, according to a control signal from the L/R switch control unit 170, and then outputs the selected image.

The L/R switch control unit 170 generates the control signal such that the selector 180 outputs the left-eye images 58L and the right-eye images 58R alternately at 60p, and then outputs the generated control signal to the selector 180. Through the processing of the L/R switch control unit 170 and the selector 180, the selector 180 generates the output 3D image data 58 in which the left-eye images 58L and the right-eye images 58R are alternately disposed. The output 3D image data 58 is an image data of 60p.

Next, a detailed structure of the memory unit 120 is described.

As shown in FIG. 4, the memory unit 102 includes a first memory 121, a second memory 122, and a third memory 123. Each of the first memory 121 to the third memory 123 stores one of the photograph data generated by the decoder 110. The same number of these memories is prepared as the number of photograph data. In the present embodiment, descriptions are given assuming that the number of photograph data is three.

Next, a detailed structure of the display position control unit 130 is described.

As shown in FIG. 4, the same number of display position control units 130 is provided as the number of photograph data, and each of the display position control units 130 includes an L display position control unit 132L and an R display position control unit 132R. Because of space limitations, FIG. 4 shows two display position control units 130. While the following describes the display position control unit 130 which is connected to the first memory 121, the same or like process is performed in the display position control unit 130 which is connected to the second memory 122 or the third memory 123. Detailed descriptions on the process will therefore not be repeated.

The L display position control unit 132L generates a thumbnail by scaling down the photograph data stored in the first memory 121, and determines, based on the offset determined by the offset control unit 140, a display position of the generated thumbnail in the left-eye image 58L.

The R display position control unit 132R generates a thumbnail by scaling down the photograph data stored in the first memory 121, and determines, based on the offset determined by the offset control unit 140, a display position of the generated thumbnail in the right-eye image 58R.

Next, a detailed structure of the blend ratio determination unit 150 is described.

As shown in FIG. 4, the blend ratio determination unit 150 includes a plurality of L/R blend ratio synthesis units 152 and a blend ratio control unit 156.

The blend ratio control unit 156 determines the synthesis order of thumbnails based on the offset of each thumbnail determined by the offset control unit 140. The synthesis order indicates an order in which a thumbnail to be displayed in 3D at a more forward position (closer to a viewer) is placed in a higher rank, and a thumbnail to be displayed in 3D at a position farther away from a viewer is placed in a lower rank.

The L/R blend ratio synthesis unit 152 is provided one-to-one with the display position control unit 130. The L/R blend ratio synthesis unit 152 determines the blend ratio of thumbnails at each pixel position of each of the left-eye image 58L and the right-eye image 58R based on the display positions of the thumbnails determined by the L display position control units 132L and the R display position control units 132R, and the synthesis order of the thumbnails determined by the blend ratio control unit 156.

Next, a detailed structure of the synthesis unit 160 is described.

The synthesis unit 160 includes an L synthesis unit 162L and an R synthesis unit 162R.

The L synthesis unit 162L generates the left-eye image 58L by synthesizing, at each pixel position of the left-eye image 58L, pixel vales of the plurality of thumbnails based on the blend ratios of the plurality of thumbnails, each determined by a corresponding one of the plurality of L/R blend ratio synthesis units 152. The L synthesis unit 162L outputs the generated left-eye image 58L to the selector 180.

The R synthesis unit 162R generates the right-eye image 58R by synthesizing, at each pixel position of the right-eye image 58R, pixel vales of the plurality of thumbnails based on the blend ratios of the plurality of thumbnails, each determined by a corresponding one of the plurality of L/R blend ratio synthesis units 152. The R synthesis unit 162R outputs the generated right-eye image 58R to the selector 180.

Next, a detailed structure of the offset control unit 140 is described.

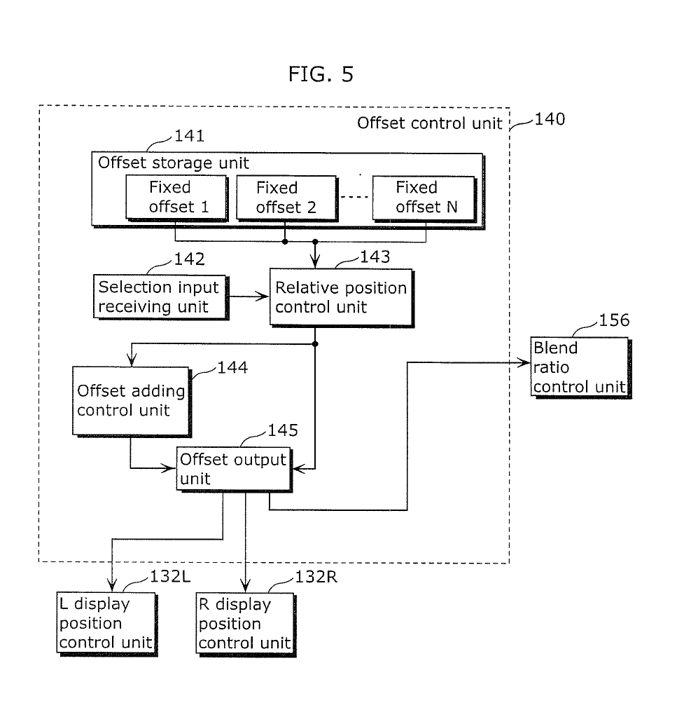

FIG. 5 is a block diagram showing a structure of the offset control unit 140.

The offset control unit 140 includes an offset storage unit 141, a selection input receiving unit 142, a relative position control unit 143, an offset adding control unit 144, and an offset output unit 145.

The offset storage unit 141 stores predetermined fixed offsets 1 to N.

The selection input receiving unit 142 receives a selection input of a thumbnail from a viewer. For example, when a thumbnail is selected using an input device such as a remote controller or a key board, an identifier of the selected thumbnail is received as the selection input of a thumbnail.

The relative position control unit 143 selects the fixed offset stored in the offset storage unit 141, based on the relation of relative positions predetermined for each of the thumbnails. Furthermore, when the selection input receiving unit 142 has received the identifier of the thumbnail, the relative position control unit 143 changes the relation of relative positions of respective thumbnails by moving, to the front most position, the relative position of the thumbnail specified by the received identifier. After changing the relation of relative positions, the relative position control unit 143 selects again the fixed offset stored in the offset storage unit 141.

When the relative position control unit 143 has changed the offset so as to increase the offset, the offset adding control unit 144 receives, from the relative position control unit 143, the offset before the change and the offset after the change, and adds a predetermined value to the offset before the change at each predetermined point in time, and accumulates the value until the resultant value reaches the offset after the change. The offset output unit 145 outputs the offset selected by the relative position control unit 143 or the offset resulting from the addition and accumulation by the offset adding control unit 144, to the L display position control unit 132L, the R display position control unit 132R, and the blend ratio control unit 156.

Next, a detailed structure of the blend ratio determination unit 150 is described.

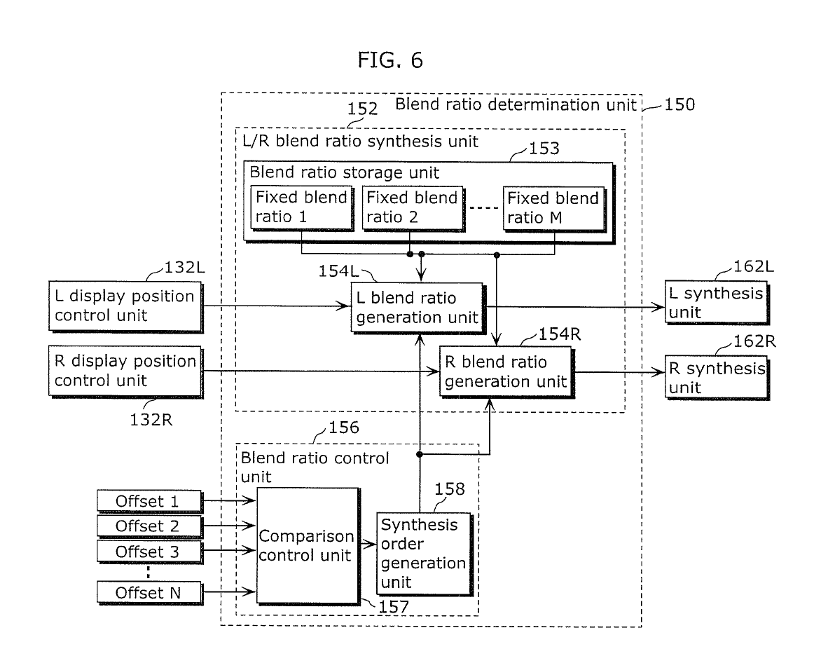

FIG. 6 is a block diagram showing a more detailed structure of the blend ratio determination unit 150. The blend ratio determination unit 150 includes the L/R blend ratio synthesis unit 152 and the blend ratio control unit 156. While FIG. 6 shows only one L/R blend ratio synthesis unit 152 because of space limitations, there are actually the same number of L/R blend ratio synthesis units 152 as the number of display position control units 130 as described above with reference to FIG. 4.

The blend ratio control unit 156 includes a comparison control unit 157 and a synthesis order generation unit 158.

The comparison control unit 157 compares the offsets of respective thumbnails determined by the offset control unit 140, thereby determining the size relation of the offsets.

The synthesis order generation unit 158 generates the synthesis order of thumbnails according to the offset size relation determined by the comparison control unit 157. This means that the synthesis order generation unit 158 places the offset with a higher value in a higher rank of the synthesis order. The synthesis order indicates an order of the blend ratio for use in synthesizing the pixel values of a plurality of thumbnails, and the L/R blend ratio synthesis unit 152 performs control such that the blend ratio is higher in a higher rank of the synthesis order.

The L/R blend ratio synthesis unit 152 includes a blend ratio storage unit 153, an L blend ratio generation unit 154L, and an R blend ratio generation unit 154R.

The blend ratio storage unit 153 stores predetermined fixed blend ratios 1 to M. Here, the fixed blend ratio j (where j=1 to M) increases as the value j decreases.

The L blend ratio generation unit 154L selects, at each pixel position of the left-eye image 58L, the fixed blend ratio stored in the blend ratio storage unit 153, based on the display position of the thumbnail, in the left-eye image 58L, determined by the L display position control unit 132L, and the synthesis order of the thumbnail determined by the synthesis order generation unit 158. This means that the L blend ratio generation unit 154L selects, at a pixel position at which a plurality of the thumbnails overlap, the fixed blend ratio with a larger value for the thumbnail higher in the rank of the synthesis order determined by the synthesis order generation unit 158, from among the fixed blend ratios stored in the blend ratio storage unit 153. The L blend ratio generation unit 154L outputs the selected fixed blend ratio to the L synthesis unit 162L.

Likewise, the R blend ratio generation unit 154R selects, at each pixel position of the right-eye image 58R, the fixed blend ratio stored in the blend ratio storage unit 153, based on the display position of the thumbnail, in the right-eye image 58R, determined by the R display position control unit 132R, and the synthesis order of the thumbnail determined by the synthesis order generation unit 158. This means that the R blend ratio generation unit 154R selects, at a pixel position at which a plurality of the thumbnails overlap, the fixed blend ratio with a larger value for the thumbnail higher in the rank of the synthesis order determined by the synthesis order generation unit 158, from among the fixed blend ratios stored in the blend ratio storage unit 153. The R blend ratio generation unit 154R outputs the selected fixed blend ratio to the R synthesis unit 162R.

Next, the process of each of the processing units is described in detail.

The following descriptions assume that three photograph data are stored in the first memory 121 to the third memory 123, and these three photograph data are referred to as thumbnails A, B, and C.

First, three processes executed by the offset control unit 140 (the first to third processes executed by the offset control unit 140) are described in detail.

### (First Process by the Offset Control Unit 140)

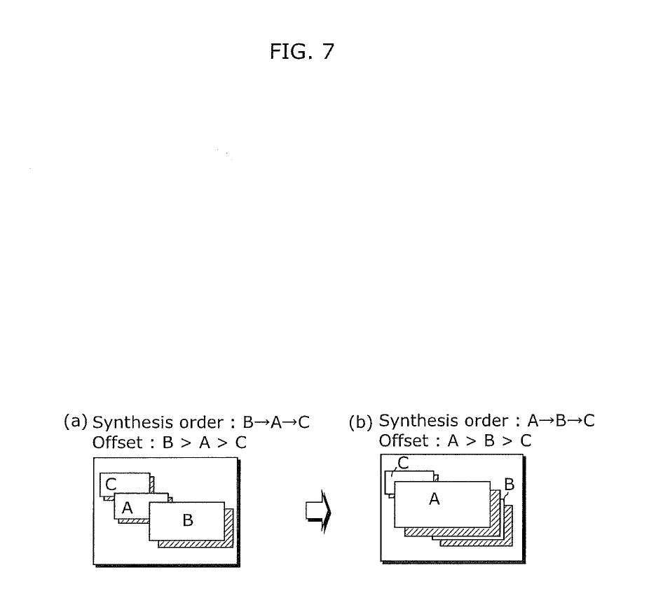

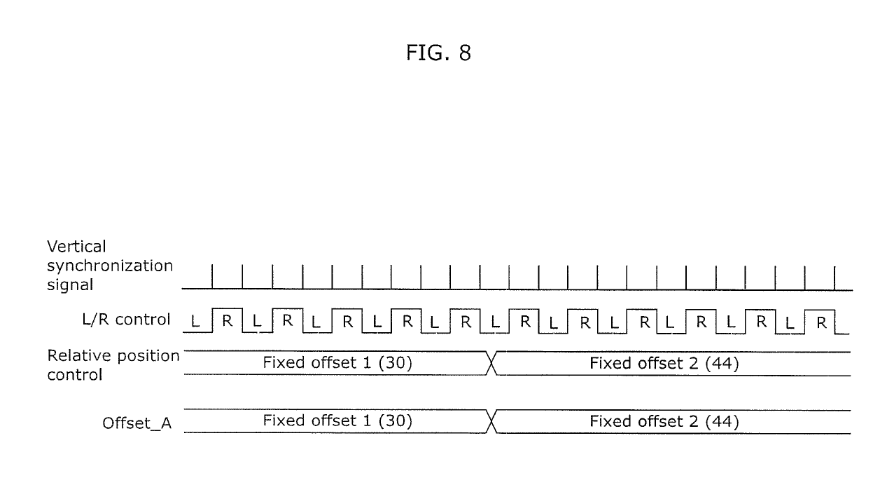

FIG. 7 shows transition of the offsets and the display positions of the thumbnails. FIG. 8 is a timing chart of the process which the offset control unit 140 executes at the time of transition shown in FIG. 7.

Assume that, as shown in (a) in FIG. 7, the relation of relative positions (synthesis order) of the thumbnails A to C is set in advance such that the thumbnails B, A, and C are arranged in this order from the front most position. Accordingly, the relative position control unit 143 selects the offsets from the offset storage unit 141 so that the size decreases in the following order: the thumbnail B, the thumbnail A, and the thumbnail C. For example, assume that, as shown in FIG. 8, the L/R switch control unit 170 switches, according to a vertical synchronization signal, between an L control signal (which is referred to as “L” in the figure) and an R control signal (which is referred to as “R” in the figure) on a per one vertical synchronization period basis. At the time of output of the L control signal, the selector 180 outputs the left-eye image 58L generated by the L synthesis unit 162L, and the time of output of the R control signal, the selector 180 outputs the right-eye image 58R generated by the R synthesis unit 162R. Furthermore, assume, for example, that the relative position control unit 143 selects the fixed offset 1 (for example, 30 in size) as the offset of the thumbnail A (which is referred to as “relative position control” in the figure). The offset output unit 145 then outputs the fixed offset 1 selected by the relative position control unit 143, to the L display position control unit 132L, the R display position control unit 132R, and the blend ratio control unit 156 (which is referred to as “offset_A” in the figure).

Next, assume that the selection input receiving unit 142 receives a selection input of the thumbnail A from a viewer. In this case, the relative position control unit 143 re-selects the offsets so that the offset of the selected thumbnail A becomes largest. That is, the relative position control unit 143 re-selects the offsets so that the offset decreases in the following order: the thumbnail A, the thumbnail B, and the thumbnail C. For example, as shown in FIG. 8, the relative position control unit 143 re-selects, instead of the fixed offset 1, the fixed offset 2 (for example, 44 in size) that is larger than the fixed offset 1. By so doing, the synthesis order which is set to have the thumbnails B, A, and C in this order is changed to the order in which the thumbnail A is the first. That is, as shown in (b) in FIG. 7, the synthesis order is changed to the following order: the thumbnail A, the thumbnail B, and the thumbnail C. Furthermore, the offset output unit 145 outputs the fixed offset 2 re-selected by the relative position control unit 143, to the L display position control unit 132L, the R display position control unit 132R, and the blend ratio control unit 156.

Through the first process shown FIGS. 7 and 8 which is executed by the offset control unit 140, a viewer's selection of a thumbnail allows the offset of the selected thumbnail to be largest. It is therefore possible to eliminate the feeling of strangeness in 3D presentation. Moreover, the selected thumbnail can be promptly displayed in front.

Furthermore, the L display position control unit 132L controls the display position of the thumbnail A in the left-eye image 58L so that the thumbnail A with the fixed offset 2 is larger in size than the thumbnail A with the fixed offset 1 when displayed. Likewise, the R display position control unit 132R controls the display position of the thumbnail A in the right-eye image 58R so that the thumbnail A with the fixed offset 2 is larger in size than the thumbnail A with the fixed offset 1 when displayed.

### (Second Process by the Offset Control Unit 140)

In the first process by the offset control unit 140, the input of a selection of a thumbnail causes a prompt change in the offset thereof. The offset control unit 140 may execute, instead of the first process, the second process described below. In the second process, the input of a selection of a thumbnail causes not a prompt change, but a gradual change, in the offset.

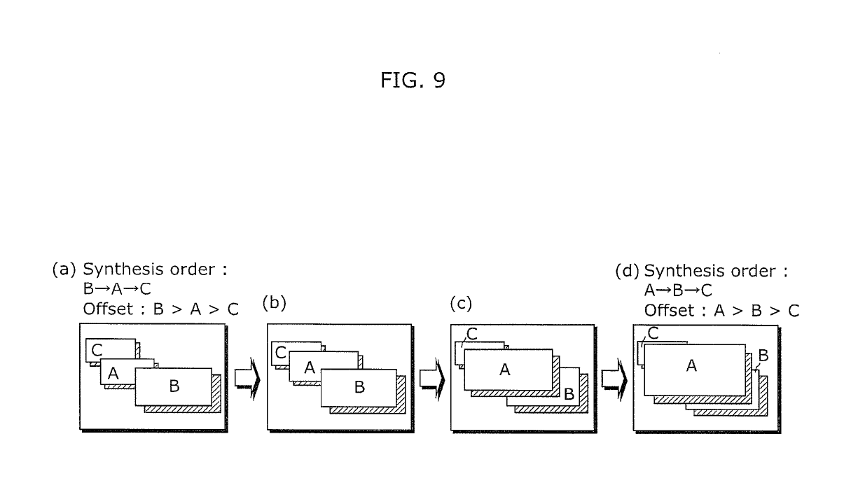

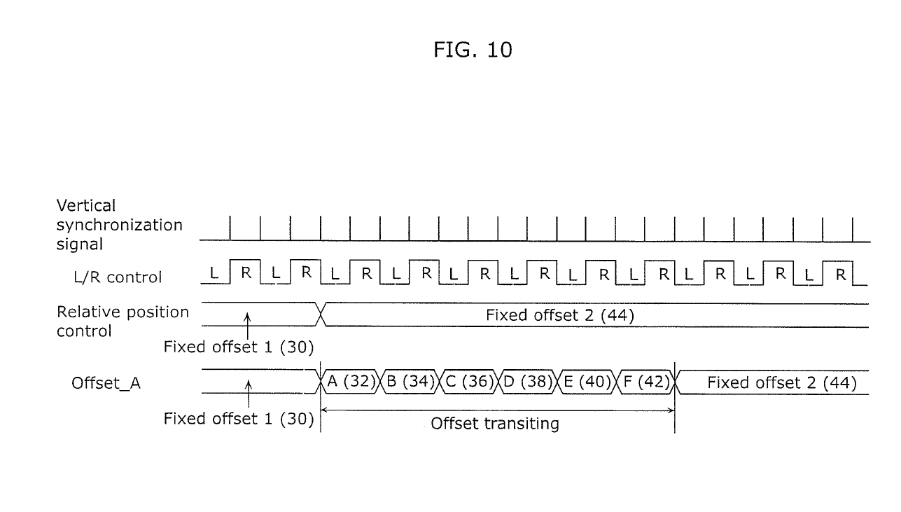

FIG. 9 shows transition of the offsets and the display positions of the thumbnails. FIG. 10 is a timing chart of the process which the offset control unit 140 executes at the time of transition shown in FIG. 9.

Assume that, as shown in (a) in FIG. 9, the synthesis order of the thumbnails A to C is set in advance such that the thumbnails B, A, and C are arranged in this order from the front most position. Accordingly, the relative position control unit 143 selects the offsets from the offset storage unit 141 so that the size decreases in the following order: the thumbnail B, the thumbnail A, and the thumbnail C. For example, assume that, as shown in FIG. 10, the L/R switch control unit 170 switches, according to a vertical synchronization signal, between an L control signal (which is referred to as “L” in the figure) and an R control signal (which is referred to as “R” in the figure) on a per one vertical synchronization period basis. Furthermore, assume, for example, that the relative position control unit 143 selects the fixed offset 1 (for example, 30 in size) as the offset of the thumbnail A (which is referred to as “relative position control” in the figure). The offset output unit 145 then outputs the fixed offset 1 selected by the relative position control unit 143, to the L display position control unit 132L, the R display position control unit 132R, and the blend ratio control unit 156 (which is referred to as “offset_A” in the figure).

Next, assume that the selection input receiving unit 142 receives a selection input of the thumbnail A from a viewer. In this case, the relative position control unit 143 re-selects the offset so that the offset of the selected thumbnail A becomes largest. That is, the relative position control unit 143 re-selects the offsets so that the offset decreases in the following order: the thumbnail A, the thumbnail B, and the thumbnail C. For example, as shown in FIG. 10, the relative position control unit 143 re-selects, instead of the fixed offset 1, the fixed offset 2 (for example, 44 in size) that is larger than the fixed offset 1.

The offset adding control unit 144 adds a predetermined value to the fixed offset 1 that has been selected before the re-selection, on a per two vertical synchronization periods basis, and accumulates the value until the resultant value reaches the fixed offset 2 re-selected by the relative position control unit 143. For example, as shown in FIG. 10, the offset adding control unit 144 adds the predetermined value 2 to the fixed offset 1 (that is 30 in size) on a per two vertical synchronization periods basis, and accumulates the value until the resultant value reaches the fixed offset 2 (that is 44 in size). As a result, the offset is updated in the following order: 30, 32, 34, 36, 38, 40, 42, and 44. FIG. 9 shows, in (b) and (c) thereof, the thumbnails whose offsets are undergoing transition from 30 to 44, which shows that the offset gradually increases as the area of the thumbnail A gradually increases. Furthermore, it shows that the rank of the thumbnail A in the synthesis order gradually increases.

As shown in FIG. 10, the offset of the thumbnail A ultimately becomes the fixed offset 2 (44). Accordingly, the thumbnail A becomes the first in the synthesis order as shown in (d) in FIG. 9.

Through the second process shown FIGS. 9 and 10 which is executed by the offset control unit 140, a viewer's selection of a thumbnail allows the offset of the selected thumbnail to be largest. It is therefore possible to eliminate the feeling of strangeness in 3D presentation. Furthermore, viewers can be provided with a visual effect to have the selected thumbnail gradually displayed to the front.

### (Third Process by the Offset Control Unit 140)

In the first process by the offset control unit 140, the input of a selection of a thumbnail causes a change in the offset. The offset control unit 140 may execute, instead of the first process, the third process described below. The third process is the same as the first process in that the input of a selection of a thumbnail causes a change in the offset. However, in the third process, the offset for a selected and input thumbnail has been stored in the offset storage unit 141, and the stored offset is selected at the time of selection and input, which are different from the first process.

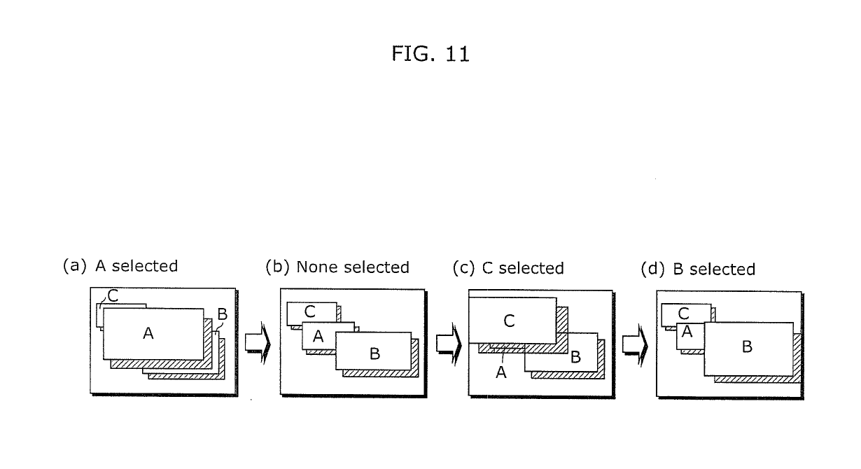

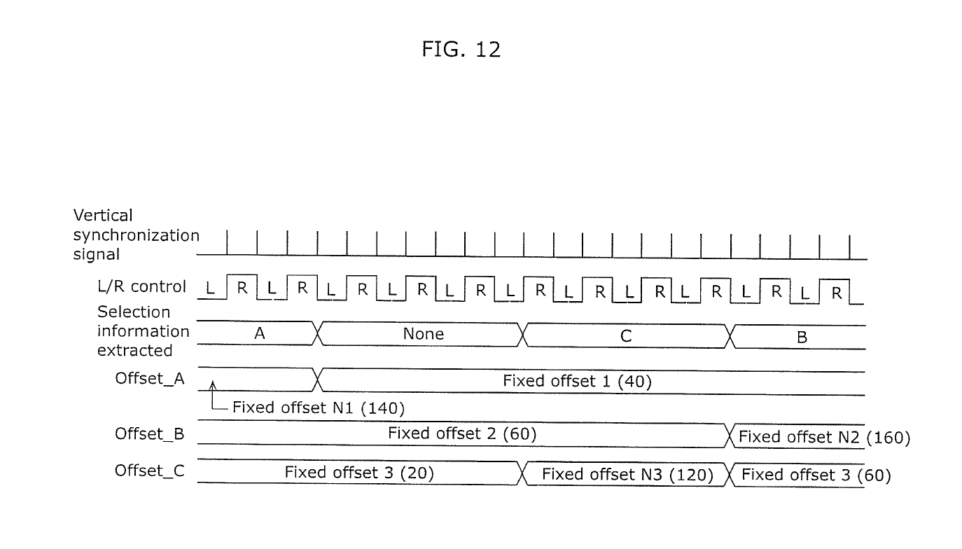

FIG. 11 shows transition of the offsets and the display positions of the thumbnails. FIG. 12 is a timing chart of the process which the offset control unit 140 executes at the time of transition shown in FIG. 11.

For example, the fixed offsets 1, 2, and 3 have been previously assigned to the thumbnails A, B, and C, respectively. Assume that the fixed offsets 1, 2, and 3 are 40, 60, and 20 in size, respectively. Under such a condition, assume that, as shown in (a) in FIG. 11, the selection input receiving unit 142 has received a selection input of the thumbnail A (which is referred to as “selection information extracted” in FIG. 12). The relative position control unit 143 then selects, as shown in FIG. 12, a fixed offset N1 (for example, 140 in size) from the offset storage unit 141 as the offset of the thumbnail A (which is referred to as “offset_A” in FIG. 12). The following descriptions assume that each of the fixed offsets N1, N2, and N3 is an offset for the selected and input thumbnail. Furthermore, assume that the fixed offsets N1, N2, and N3 have larger values than the ordinary offsets (the fixed offsets 1, 2, and 3).

With no selection input from the selection input receiving unit 142 as shown in (b) in FIG. 11, the relative position control unit 143 assigns the fixed offsets 1, 2, and 3 to the thumbnails A, B, and C, respectively, as shown in FIG. 12.

Assume that the selection input receiving unit 142 receives a selection input of the thumbnail C as shown in (c) in FIG. 11. The relative position control unit 143 then selects, as shown in FIG. 12, a fixed offset N3 (for example, 120 in size) from the offset storage unit 141 as the offset of the thumbnail C (which is referred to as “offset_C” in FIG. 12).

Furthermore, assume that the selection input receiving unit 142 receives a selection input of the thumbnail B as shown in (d) in FIG. 11. The relative position control unit 143 then selects, as shown in FIG. 12, a fixed offset N2 (for example, 160 in size) from the offset storage unit 141 as the offset of the thumbnail B (which is referred to as “offset_B” in FIG. 12).

Through the third process shown FIGS. 11 and 12 which is executed by the offset control unit 140, a viewer's selection of a thumbnail allows the offset of the selected thumbnail to be largest. It is therefore possible to eliminate the feeling of strangeness in 3D presentation.

It is to be noted that the first to third processes which the offset control unit 140 executes may be combined. For example, the offset control unit 140 may execute a process in which the second process and the third process are combined.

### (Process by the Blend Ratio Determination Unit 150)

Next, a process which the blend ratio determination unit 150 executes is described in detail.

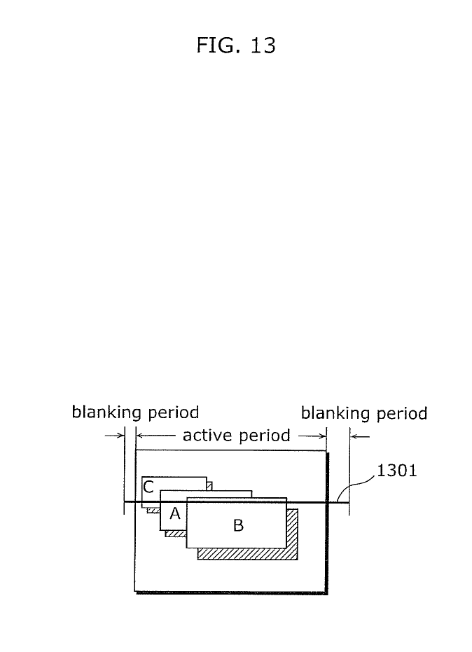

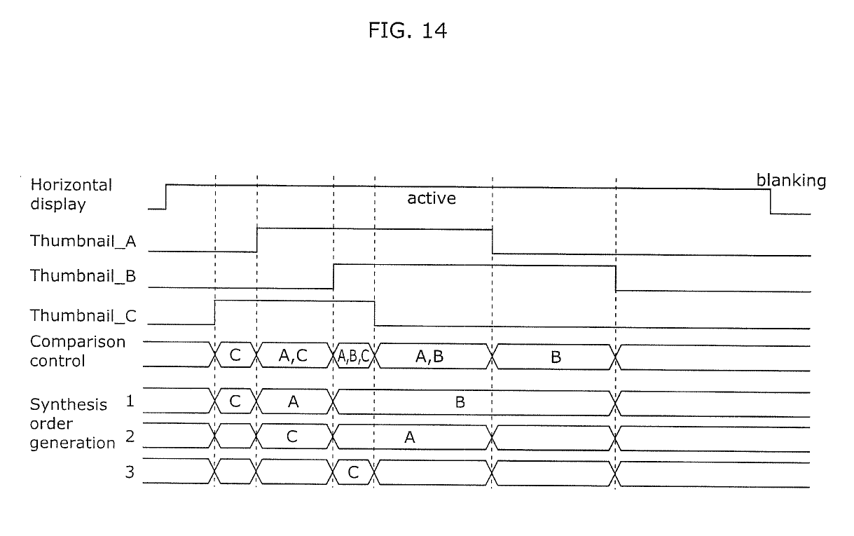

First, with reference to FIGS. 13 and 14, a process which the blend ratio control unit 156 executes is described.

FIG. 13 shows an example of images displayed on the display panel 26. In a certain one horizontal synchronization period, images are displayed on a scanning line 1301.

FIG. 14 is a timing chart of a process which the blend ratio control unit 156 executes. In the chart, “horizontal display” indicates a horizontal scanning signal in scanning from left to right on the scanning line 1301, whose High indicates an active period and whose Low indicates a blanking period.

The chart indicates, in “thumbnail_A”, that the thumbnail A is rendered in the High period while the thumbnail A is not rendered in the Low period. Likewise, the chart indicates, in “thumbnail_B”, that the thumbnail B is rendered in the High period while the thumbnail B is not rendered in the Low period. Furthermore, the chart indicates, in “thumbnail_C”, that the thumbnail C is rendered in the High period while the thumbnail C is not rendered in the Low period.

In the chart, “comparison control” indicates a thumbnail having an offset to be compared by the comparison control unit 157. Specifically, in scanning the scanning line 1301 from left, there is no offset to be compared at first, and then, only the thumbnail C is displayed, which means that only the offset of the thumbnail C is to be compared. Next, the thumbnails A and C are displayed in layers, which means that the offsets of the thumbnails A and C are to be compared. Next, the thumbnails A to C are displayed in layers, which means that the offsets of the thumbnails A to C are to be compared. Subsequently, the thumbnails A and B are displayed in layers, which means that the offsets of the thumbnails A and B are to be compared. Next, only the thumbnail B is displayed, which means that only the offset of the thumbnail B is to be compared. At the end, none of the thumbnails are displayed, which means there is no offset any more to be compared.

The comparison control unit 157 determines the size relation of the offsets among these offsets to be compared. According to the offset size relation determined by the comparison control unit 157, the synthesis order generation unit 158 determines the synthesis order of the thumbnails such that the rank in the synthesis order increases as the value of the offset increases. The result of the synthesis order is indicated in “synthesis order generation” in FIG. 14. The synthesis order generation 1 indicates the first thumbnail in the synthesis order, the synthesis order generation 2 indicates the second thumbnail in the synthesis order, and the synthesis order generation 3 indicates the third thumbnail in the synthesis order.

Specifically, first, in a state where none of the thumbnails are ranked in the synthesis order, the thumbnail C is ranked first in the synthesis order. The synthesis order is then changed to the following order: the thumbnail A and the thumbnail C. Subsequently, the synthesis order is then changed to the following order: the thumbnail B, the thumbnail A, and the thumbnail C. Next, the synthesis order is changed to the following order: the thumbnail B and the thumbnail A.

The synthesis order is then changed to the following order: the thumbnail B. At the end, the state transits to the state where none of the thumbnails are ranked in the synthesis order.

Next, a process which the L/R blend ratio synthesis unit 152 executes is described.

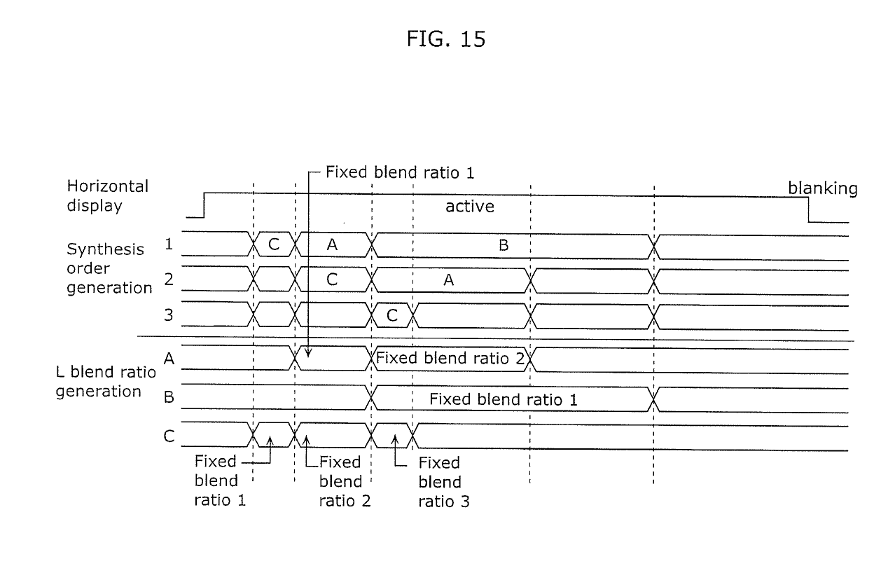

FIG. 15 is a timing chart of a process which the L blend ratio generation unit 154L of the L/R blend ratio synthesis unit 152 executes. This figures shows, as in the timing chart of FIG. 14, a timing chart in displaying images on the scanning line 1301 shown in FIG. 13. While the following describes the process of the L blend ratio generation unit 154L, the process of the R blend ratio generation unit 154R is the same or alike. Detailed descriptions on the process will therefore not be repeated.

In FIG. 15, “horizontal display” and “synthesis order generation” indicate the same as “horizontal display” and “synthesis order generation” indicated in FIG. 14. Detailed descriptions on those will therefore not be repeated.

In FIG. 15, “L blend ratio generation” indicates the blend ratio of each of the thumbnails A to C generated by the L blend ratio generation unit 154L. The L blend ratio generation unit 154L receives, at each pixel position on the scanning line 1301, the synthesis order from the synthesis order generation unit 158, selects the fixed blend ratio 1 from the blend ratio storage unit 153, and assigns the fixed blend ratio 1 to the first thumbnail in the synthesis order. Likewise, the L blend ratio generation unit 154L selects the fixed blend ratio 2 from the blend ratio storage unit 153, and assigns the fixed blend ratio 2 to the second thumbnail in the synthesis order. Furthermore, the L blend ratio generation unit 154L selects the fixed blend ratio 3 from the blend ratio storage unit 153, and assigns the fixed blend ratio 3 to the third thumbnail in the synthesis order.

As shown in FIG. 15, first, in the state where no synthesis order is given, the thumbnail C is ranked first in the synthesis order, and then the fixed blend ratio 1 is assigned to the thumbnail C. Next, the synthesis order is changed to the following order: the thumbnail A and the thumbnail C, and then, the fixed blend ratios 1 and 2 are assigned to the thumbnails A and C, respectively. Next, the synthesis order is changed to the following order: the thumbnail B, the thumbnail A, and the thumbnail C, and then, the fixed blend ratios 1, 2, and 3 are assigned to the thumbnails B, A, and C, respectively. Next, the synthesis order is changed to the following order: the thumbnail B and the thumbnail A, and then, the fixed blend ratios 1 and 2 are assigned to the thumbnails B and A, respectively. Furthermore, the synthesis order is changed to the following order: the thumbnail B, and then, the fixed blend ratio 1 is assigned to the thumbnail B. Ultimately, the state transits to the state where no synthesis order is given, and no fixed blend ratio is assigned to any of the thumbnails.

The L synthesis unit 162L generates the left-eye image 58L by synthesizing, for each pixel, the pixel values of the thumbnails according to the blend ratio determined by the L blend ratio generation unit 154L. For example, assume that the blend ratio of n thumbnails Si (where i=1 to n) is Bi (where i=1 to n). Furthermore, assuming that the pixel value of the thumbnail Si at the pixel position (x, y) is Si (x, y), the pixel value SS (x, y) of the synthesized image SS at the same pixel position is calculated by the following expression (1). Likewise, the R synthesis unit 162R generates the right-eye image 58R by synthesizing the pixel values of the thumbnails.

$$\begin{matrix}[ Math 1 ] & \\ SS ( x , y ) = {\sum }_{i = 1}^{n} ( \frac{Bi}{{\sum }_{j = 1}^{N} Bj} \times Si ( x , y ) ) & ( 1 )\end{matrix}$$

As described above, the 3D image processing apparatus according to the present embodiment links the offset and the blend ratio of the thumbnail to each other, thereby performing control such as to make the blend ratio large when the offset is large. It is therefore possible to generate image signals of images which bring no feeling of strangeness to viewers.

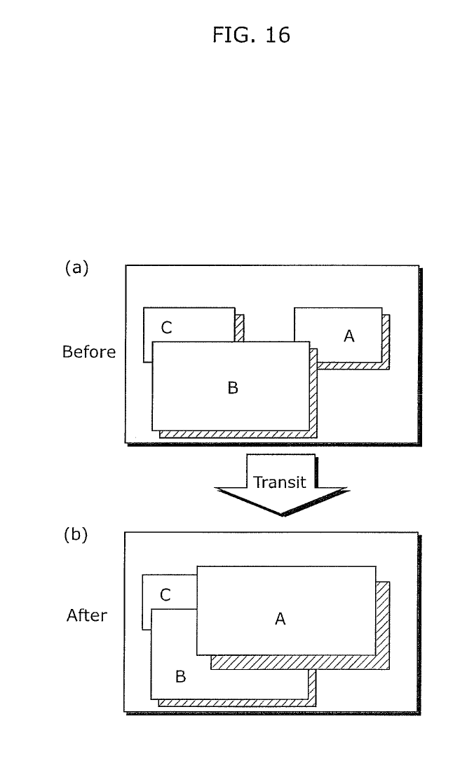

For example, assume that the thumbnail A is selected in a 3D image in which the thumbnail B is displayed over the thumbnails A and C as shown in (a) in FIG. 16. In this case, as shown in (b) in FIG. 16, the offset of the thumbnail A is largest. Furthermore, the blend ratio of the thumbnail A is largest. It is therefore possible to generate the output 3D image data 58 by which a viewer feels that the thumbnail A is located at the front most position in 3D presentation. Thus, it is possible to generate image signals of images which bring no feeling of strangeness to a viewer.

### (Variation of First Embodiment)

In the first embodiment, at a pixel position where a plurality of thumbnails overlap, the pixel values of the thumbnails are blended according to the blend ratio, thereby producing an effect which displays a rear position thumbnail in a transparent state. In the present variation, at a pixel position where a plurality of thumbnails overlap, only the thumbnail at the front most position can be displayed so that the thumbnail at a rear position will not be seen in a transparent state.

The present variation is the same as the first embodiment except a structure of the blend ratio determination unit 150. Accordingly, the following describes the blend ratio determination unit 150 without repeating descriptions on the other components.

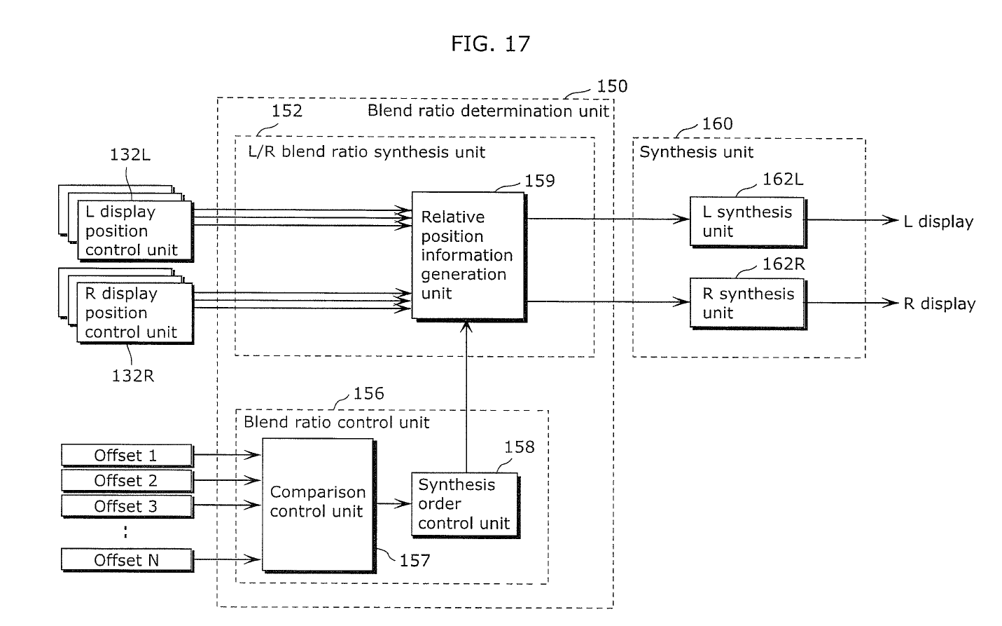

FIG. 17 is a block diagram showing a structure of the blend ratio determination unit 150.

The blend ratio determination unit 150 includes the L/R blend ratio synthesis unit 152 and the blend ratio control unit 156. While there are the plurality of the blend ratio determination units 150 in the first embodiment, only one blend ratio determination unit 150 is provided in the present variation.

The blend ratio control unit 156 has the same structure as that shown in the first embodiment.

The L/R blend ratio synthesis unit 152 includes a relative position information generation unit 159. The relative position information generation unit 159 is connected to all the L display position control units 132L and the R display position control units 132R. The relative position information generation unit 159 determines the thumbnail to be displayed at the front most position at each pixel position of the left-eye image 58L based on the display positions, in the left-eye image 58L, of the thumbnails determined by the L display position control unit 132L, and the synthesis order of the thumbnails determined by the synthesis order generation unit 158. The relative position information generation unit 159 determines the thumbnail to be displayed at the front most position at each pixel position of the right-eye image 58R as well. The following describes the left-eye image 58L only. Since the process on the right-eye image 58R is alike, detailed descriptions on the process will not be repeated.

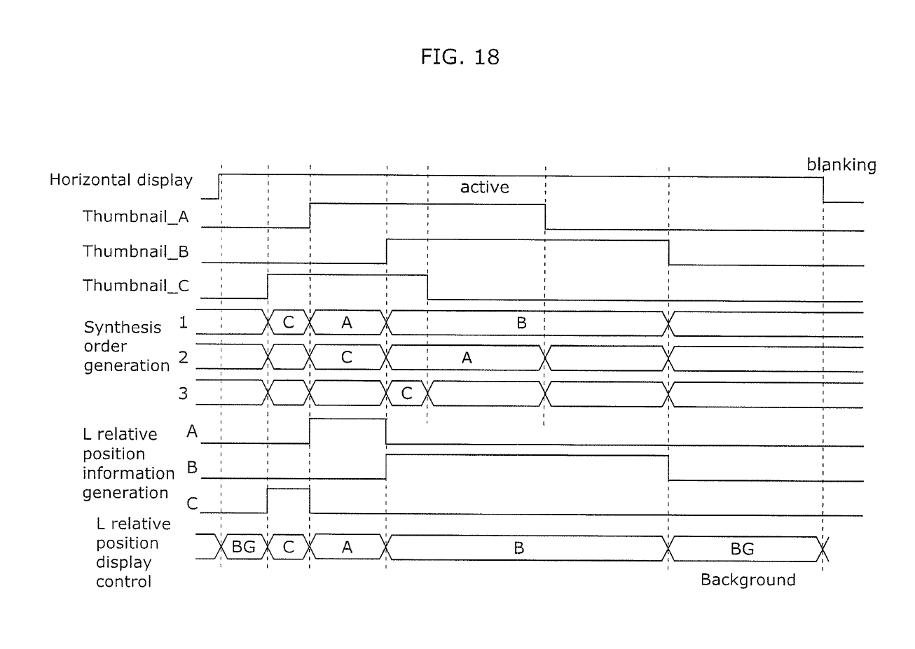

FIG. 18 is a timing chart of a process which the relative position information generation unit 159 executes. This figures shows, as in the timing chart of FIG. 14, a timing chart in displaying images on the scanning line 1301 shown in FIG. 13.

In FIG. 18, “horizontal display”, “thumbnail_A”, “thumbnail_B”, “thumbnail_C”, and “synthesis order generation” are the same as those shown in FIG. 14.

The signal “L relative position information generation” is a signal which indicates a period in which the thumbnail is ranked first in the synthesis order, and there are three signals of the L relative position information generations A to C. The L relative position information generation A is a signal which is High when the thumbnail A is ranked first in the synthesis order, and is Low in the other cases. The L relative position information generation B is a signal which is High when the thumbnail B is ranked first in the synthesis order, and is Low in the other cases. The L relative position information generation C is a signal which is High when the thumbnail C is ranked first in the synthesis order, and is Low in the other cases. The relative position information generation unit 159 controls levels of these three signals according to the synthesis order output from the synthesis order generation unit 158.

The signal “L relative position display control” is a signal which indicates the thumbnail to be displayed at the front most position. Specifically, the L relative position display control indicates the thumbnail which is ranked first in the synthesis order, and in the case where no thumbnail is ranked first in the synthesis order, the L relative position display control indicates the background (BG). That is, in scanning from left to right on the scanning line 1301, the relative position information generation unit 159 outputs the L relative position display control to the L synthesis unit 162L in the following order: the background (BG), the thumbnail C, the thumbnail A, the thumbnail B, and the background (BG). With reference to the L relative position display control, the L synthesis unit 162L determines, in each pixel of the left-eye image 58L on the scanning line 1301, the thumbnail to be displayed at the front most position. For example, in a pixel for which the thumbnail A is designated by the L relative position display control, the pixel value of the thumbnail A becomes the pixel value of the left-eye image 58L without synthesis with the pixel values of the other thumbnails. The same goes for the case where the thumbnail B or C is designated by the L relative position display control. In the case where the background is designated by the L relative position display control, since no thumbnails are present at that position, the pixel value of the background becomes the pixel value of the left-eye image 58L.

As described above, the 3D image processing apparatus according to the variation of the first embodiment performs control such as to display only the thumbnail whose offset is largest. Such control is equivalent to the setting of the blend ratio 100% for the thumbnail at the front most position while setting the blend ratio 0% for the other thumbnails. It is therefore possible to generate image signals of images which bring no feeling of strangeness to viewers.

### Second Embodiment

Next, the second embodiment is described. The second embodiment is different from the first embodiment in a structure of the 3D image processing apparatus.

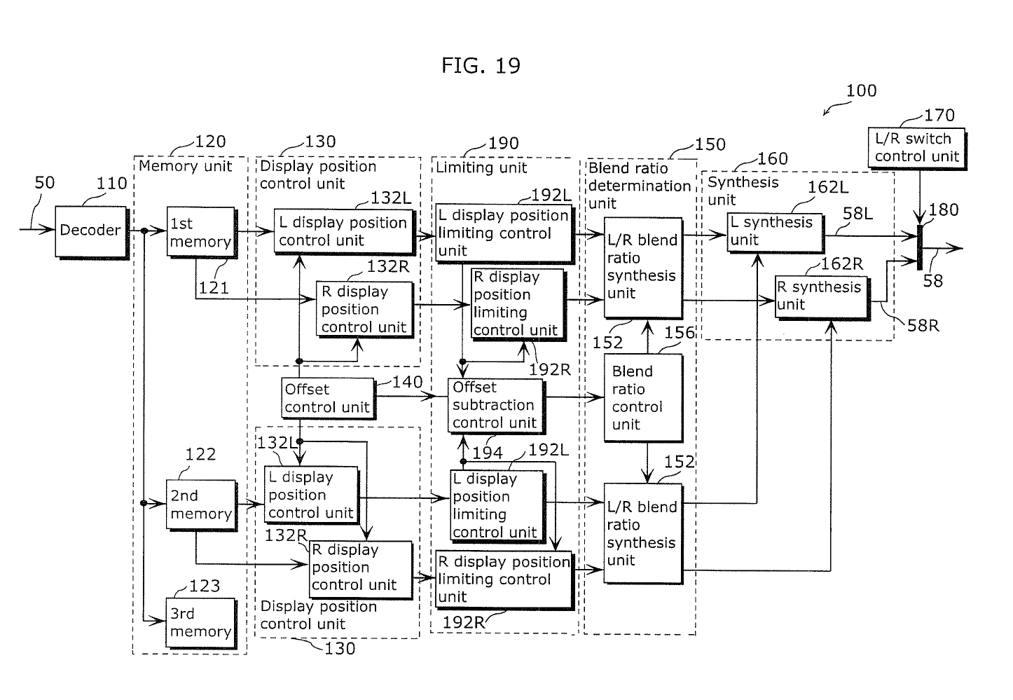

FIG. 19 is a block diagram showing the structure of the 3D image processing apparatus according to the second embodiment of the present invention.

The 3D image processing apparatus 100 includes a limiting unit 190 between the display position control unit 130 and the blend ratio determination unit 150, in addition to the structure of the 3D image processing apparatus 100 according to the first embodiment shown in FIG. 4.

The limiting unit 190 limits the display region of each thumbnail determined by the display position control unit 130, so that the display region is within the displayable regions of the left-eye image 58L and the right-eye image 58R, in the case where the display region of the thumbnail is located outside the displayable regions of the left-eye image 58L and the right-eye image 58R.

The limiting unit 190 includes a plurality of L display position limiting control units 192L provided for the respective L display position control units 132L, a plurality of R display position limiting control units 192R provided for the respective R display position control units 132R, and an offset subtraction control unit 194 connected to the offset control unit 140.

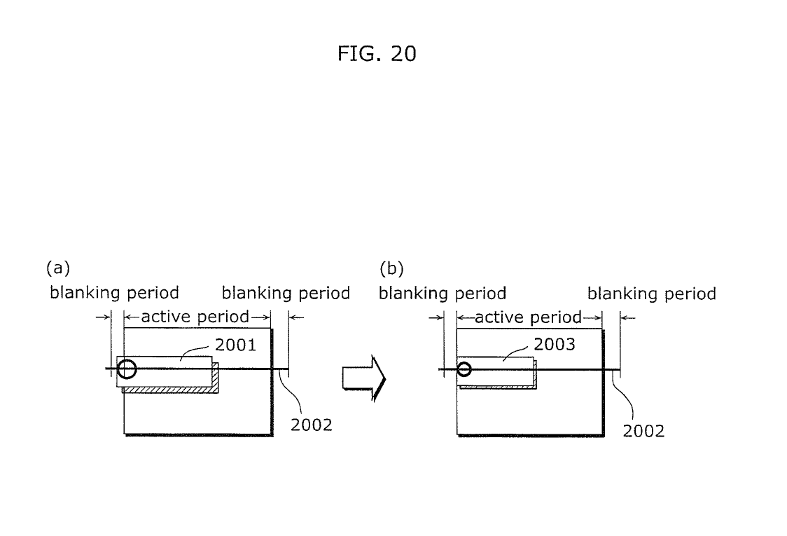

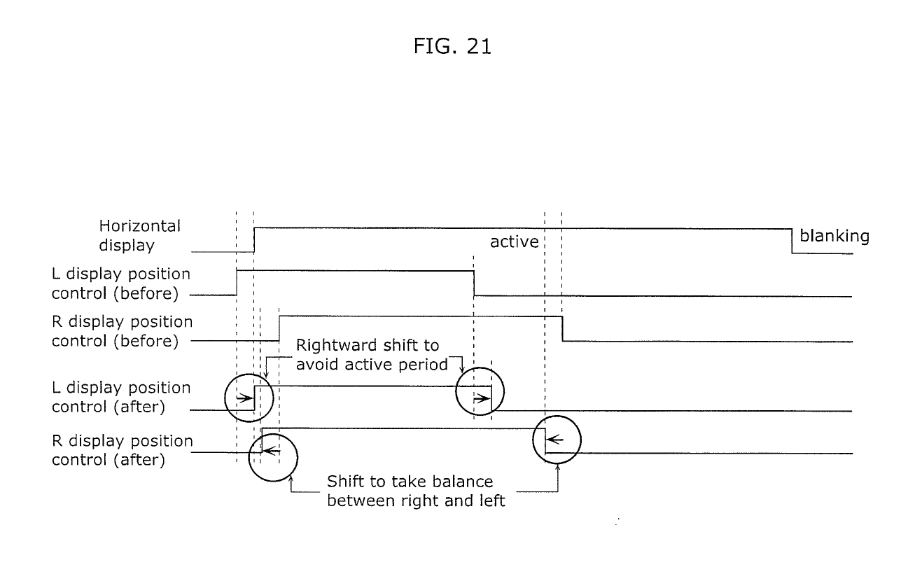

With reference to FIGS. 20 and 21, a process which the limiting unit 190 executes is described. FIG. 20 shows a change in the display position of a thumbnail displayed in 3D; FIG. 20 shows, in (a), the display position of the thumbnail which has not yet been processed by the limiting unit 190, and FIG. 20 shows, in (b), the display position of the thumbnail which has already been processed by the limiting unit 190.

FIG. 21 is a timing chart of a process which the L display position limiting control unit 192L and the R display position limiting control unit 192R execute.

Assume that, as shown in (a) in FIG. 20, the display position of a thumbnail 2001 in 3D is located outside the displayable region of the left-eye image 58L or the right-eye image 58R. FIG. 21 shows the display position of the thumbnail in scanning from left to right on a scanning line 2002.

In FIG. 21, “horizontal display” indicates a horizontal scanning signal in scanning from left to right on the scanning line 2002, whose High indicates an active period and whose Low indicates a blanking period.

In the figure, “L display position control (before)” is a signal indicating a display period of the thumbnail which is output by the L display position control unit 132L and included in the left-eye image 58L. The period High indicates a period in which the thumbnail is displayed while the period Low indicates a period in which the thumbnail is not displayed.

In the figure, “R display position control (before)” is a signal indicating a display period of the thumbnail which is output by the R display position control unit 132R and included in the right-eye image 58R. The period High indicates a period in which the thumbnail is displayed while the period Low indicates a period in which the thumbnail is not displayed.

As can be seen from FIG. 21, the L display position control (before) becomes High at an earlier point in time than the horizontal display becomes High. As a result, the thumbnail has a region not to be displayed in the left-eye image 58L.

For this reason, in order to shift the display position of the thumbnail in the left-eye image 58L to the right, the L display position limiting control unit 192L generates a signal “L display position control (after)” which is shifted overall to the right from the L display position control (before). The L display position limiting control unit 192L generates the L display position control (after) by shifting the L display position control (before) to a position at which the signal becomes High at a later point in time than the horizontal display becomes High.

On the other hand, in order to shift the display position of the thumbnail in the right-eye image 58R to the left, the R display position limiting control unit 192R generates the R display position control (after) by shifting the R display position control (before) to the left by an amount which the L display position limiting control unit 192L shifts the L display position control (before) to the right.

The L/R blend ratio synthesis unit 152 determines the display position on the scanning line 2002 so that the thumbnail is displayed at a point in time when the L display position control (after) generated by the L display position limiting control unit 192L becomes High. Then, the L/R blend ratio synthesis unit 152 executes a process to determine the blend ratio. The L/R blend ratio synthesis unit 152 determines the display position on the scanning line 2002 so that the thumbnail is displayed at a point in time when the R display position control (after) generated by the R display position limiting control unit 192R becomes High. Then, the L/R blend ratio synthesis unit 152 executes a process to determine the blend ratio.

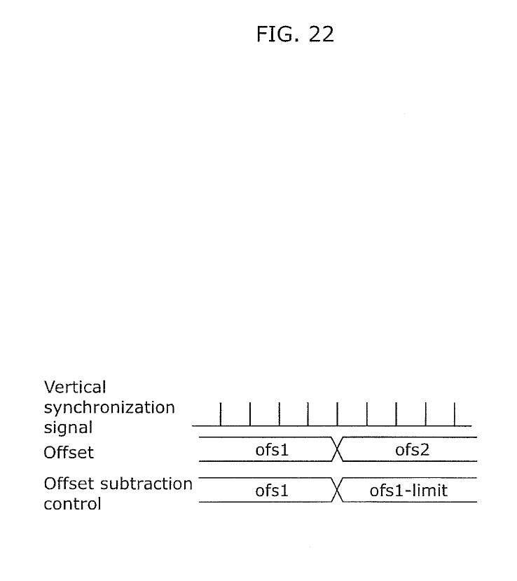

FIG. 22 is a timing chart of a process which the offset subtraction control unit 194 executes. A change in the display position control causes the offset subtraction control unit 194 to change the offset of the thumbnail from ofs1 to ofs2. Here, ofs2 has a smaller value than ofs1. Furthermore, it may be such that a change in the display position control causes the offset subtraction control unit 194 to change the offset of the thumbnail to “ofs1-limit” by subtracting a shift amount “limit” from the offset ofs1.

The display position control and the offset change in the limiting unit 190 allow a whole thumbnail 2003 to be displayed in 3D as shown in (b) in FIG. 20. The thumbnail 2003 is displayed at a deeper position than the thumbnail 2001 shown in (a) in FIG. 20. This may disrupt the relation of relative positions, but allows the entire thumbnail to be displayed and makes it possible to generate image signals of images which bring no feeling of strangeness to viewers when the images are displayed in 3D.

### (Variation of Second Embodiment)

In the second embodiment, in the case where the display region of the thumbnail is located outside the displayable region of the left-eye image 58L or the right-eye image 58R, the display position of the thumbnail is controlled to limit the display region of the thumbnail so that the display region is within the displayable regions of the left-eye image 58L and the right-eye image 58R. In the present variation, in the like case, a part of the display region of the thumbnail is deleted from the left-eye image 58L and the right-eye image 58R to limit the display region of the thumbnail so that the display region is within the displayable regions of the left-eye image 58L and the right-eye image 58R.

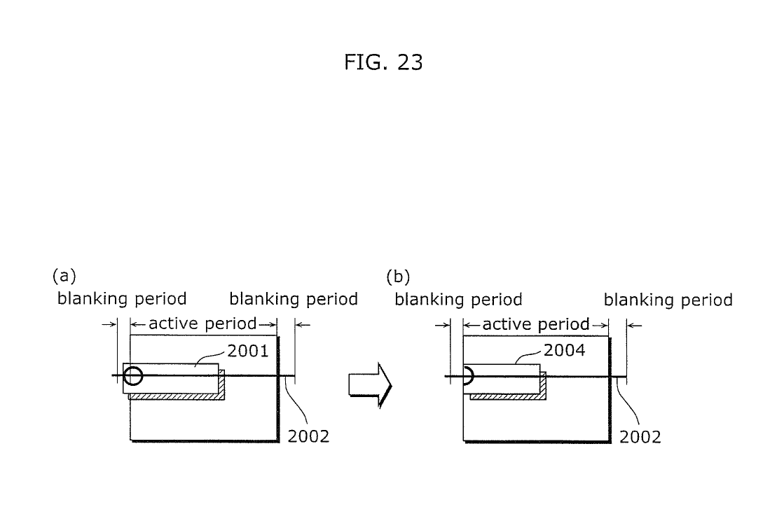

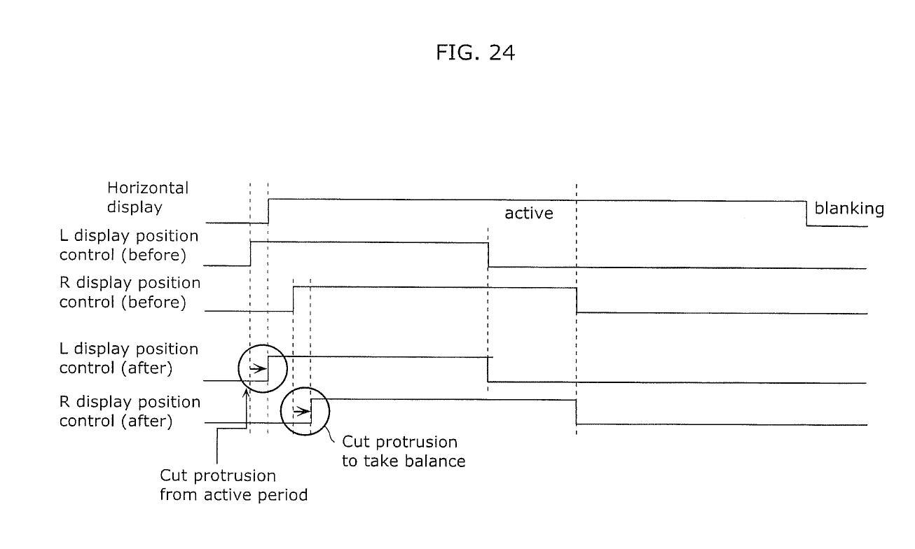

With reference to FIGS. 23 and 24, a process which the limiting unit 190 executes is described. FIG. 23 shows a change in the display position of a thumbnail displayed in 3D; FIG. 23 shows, in (a), the display position of the thumbnail which has not yet been processed by the limiting unit 190, and FIG. 23 shows, in (b), the display position of the thumbnail which has already been processed by the limiting unit 190.

FIG. 24 is a timing chart of a process which the L display position limiting control unit 192L and the R display position limiting control unit 192R execute. The meaning of each signal is the same as that shown in FIG. 21, but the method of generating the L display position control (after) and the R display position control (after) is different. Specifically, the L display position limiting control unit 192L generates the L display position control (after) by inverting, to Low, the signal L display position control (before) out of the active period of the horizontal display. Furthermore, in order to take a balance between the L display position control (after) and the R display position control (after), the R display position limiting control unit 192R changes the left-end part of the R display position control (before) in the High period to Low by a length by which the L display position control (before) changes from High to Low. By so doing, the R display position limiting control unit 192R generates the R display position control (after).

In the present variation, the offset subtraction control unit 194 executes no process. This means that the offset is not changed.

The display position control in the limiting unit 190 causes a partially-deleted thumbnail 2004 to be displayed in 3D as shown in (b) in FIG. 23. Although the partially-deleted thumbnail is displayed in 3D as above, the thumbnail can be displayed without disrupting the relation of relative positions of the thumbnails, which makes it possible to generate image signals of images which bring no feeling of strangeness to viewers when the images are displayed in 3D.

### Third Embodiment

The first and second embodiments describe the 3D image processing apparatus which generates image signals for displaying the thumbnails in layers. The third embodiment describes a 3D image processing apparatus which generates image signals for displaying graphics such as a subtitle or a diagram over video images.

First, a structure of a 3D image display system including the 3D image processing apparatus according to the third embodiment is described.

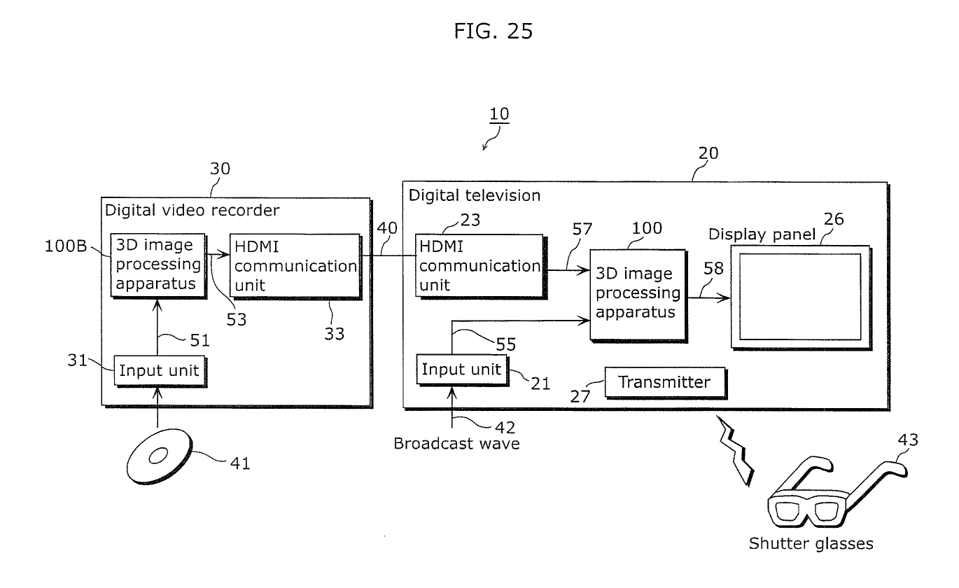

FIG. 25 is a block diagram showing a structure of the 3D image display system according to the third embodiment of the present invention.

A 3D image display system 10 shown in FIG. 25 includes a digital television 20, a digital video recorder 30, and the shutter glasses 43. The digital television 20 and the digital video recorder 30 are interconnected via a High-Definition Multimedia Interface (HDMI) cable 40.

The digital video recorder 30 coverts 3D image data recorded on an optical disc 41 such as a blu-ray disc (BD), into a format in which the data can be displayed in 3D, and outputs the resultant 3D image data to the digital television 20 via the HDMI cable 40.

The digital television 20 coverts 3D image data included in broadcast waves 42, into a format in which the data can be displayed in 3D, and displays the resultant data. For example, the broadcast waves 42 include digital terrestrial television broadcasting or digital satellite broadcasting. The digital television 20 displays the 3D image data output from the digital video recorder 30.

The digital video recorder 30 may convert 3D image data recorded on a recording medium (e.g., a hard disk drive or a non-volatile memory) other than the optical disc 41, into a format in which the data can be displayed in 3D. Furthermore, the digital video recorder 30 may convert the 3D image data included in the broadcast waves 42 or 3D image data obtained through a communications network such as the Internet, into a format in which the data can be displayed in 3D. In addition, the digital video recorder 30 may also convert 3D image data input from an external device to an external input terminal (not shown) or the like, into a format in which the data can be displayed in 3D.

Likewise, the digital television 20 may convert the 3D image data recorded on the optical disc 41 and other recording media, into a format in which the data can be displayed in 3D. Furthermore, the digital television 20 may convert the 3D image data obtained through a communications network such as the Internet, into a format in which the data can be displayed in 3D. In addition, the digital television 20 may also convert the 3D image data input from an external device other than the digital video recorder 30 to an external input terminal (not shown) or the like, into a format in which the data can be displayed in 3D.

The digital television 20 and the digital video recorder 30 may also be interconnected via a standardized cable other than the HDMI cable 40 or via a wireless communications network.

The digital video recorder 30 includes an input unit 31, a 3D image processing apparatus 100B, and an HDMI communication unit 33.

The input unit 31 receives coded 3D image data 51 recorded on the optical disc 41.

The 3D image processing apparatus 100B generates output 3D image data 53 by converting the coded 3D image data 51 received by the input unit 31, into a format in which the data can be displayed in 3D.

The HDMI communication unit 33 outputs the output 3D image data 53 generated by the 3D image processing apparatus 100B, to the digital television 20 via the HDMI cable 40.

The digital video recorder 30 may store the generated output 3D image data 53 into a storage unit (such as a hard disk drive or a non-volatile memory) included in the digital video recorder 30, or may also store the generated output 3D image data 53 onto a recording medium (such as an optical disc) which can be inserted into and removed from the digital video recorder 30.

The digital television 20 includes an input unit 21, an HDMI communication unit 23, the 3D image processing apparatus 100, the display panel 26, and the transmitter 27.

The input unit 21 receives coded 3D image data 55 included in the broadcast waves 42.

The HDMI communication unit 23 receives the output 3D image data 53 provided by the HDMI communication unit 33, and outputs them as input 3D image data 57.

The 3D image processing apparatus 100 generates the output 3D image data 58 by converting the coded 3D image data 55 received by the input unit 21, into a format in which the data can be displayed in 3D, and outputs the output 3D image data 58. Furthermore, the 3D image processing apparatus 100 generates the output 3D image data 58 using the input 3D image data 57 provided by the HDMI communication unit 23, and outputs the output 3D image data 58.

The display panel 26 displays the output 3D image data 58 provided by the 3D image processing apparatus 100.

Next, a structure of the 3D image processing apparatus 100 is described. The 3D image processing apparatus 100B has a like structure as the 3D image processing apparatus 100. Accordingly, only the 3D image processing apparatus 100 is described in detail while descriptions on the 3D image processing apparatus 100B will not be repeated.

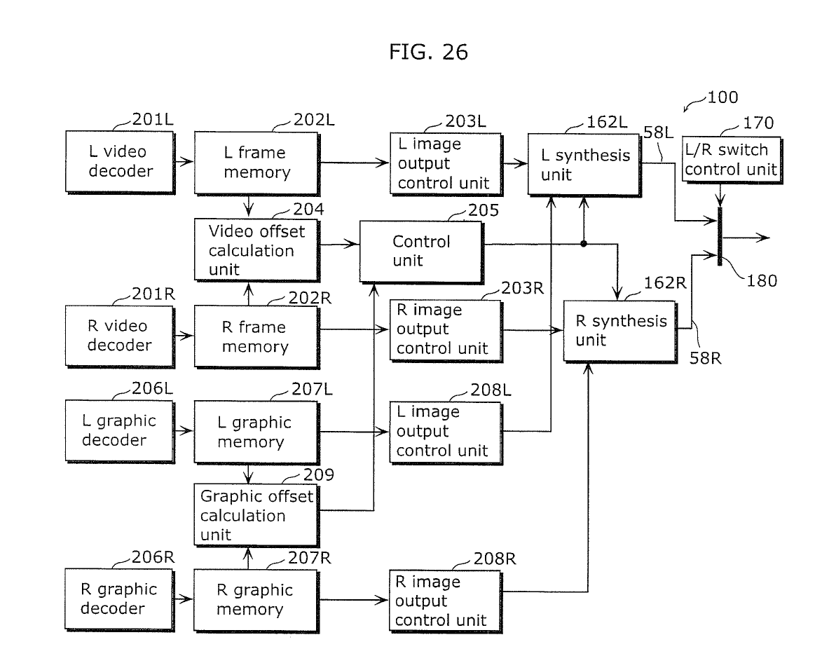

FIG. 26 is a block diagram showing the structure of the 3D image processing apparatus 100.

As shown in FIG. 26, the 3D image processing apparatus 100 includes an L video decoder 201L, an R video decoder 201R, an L frame memory 202L, an R frame memory 202R, an L image output control unit 203L, an R image output control unit 203R, a video offset calculation unit 204, a control unit 205, an L graphic decoder 206L, an R graphic decoder 206R, an L graphic memory 207L, an R graphic memory 207R, an L image output control unit 208L, an R image output control unit 208R, a graphic offset calculation unit 209, the L synthesis unit 162L, the R synthesis unit 162R, the L/R switch control unit 170, and the selector 180.

The L video decoder 201L generates left-eye video data by decoding, for each frame, coded left-eye video data included in the coded 3D image data 55.

The L frame memory 202L is a memory in which the left-eye video data generated by the L video decoder 201L is stored for each frame.

The L image output control unit 203L outputs, at a predetermined frame rate, the left-eye video data stored in the L frame memory 202L.

The R video decoder 201R generates right-eye video data by decoding, for each frame, coded right-eye video data included in the coded 3D image data 55.

The R frame memory 202R is a memory in which the right-eye video data generated by the R video decoder 201R is stored for each frame.

The R image output control unit 203R outputs, at a predetermined frame rate, the right-eye video data stored in the R frame memory 202R.

The video offset calculation unit 204 obtains, as an offset, a horizontal shift amount between the left-eye video data stored in the L frame memory 202L and the right-eye video data stored in the R frame memory 202R, based on such video data. The shift amount is calculated by pattern matching between the left-eye video data and the right-eye video data. For example, a block of a predetermined size (e.g., a block of 8×8 pixels) extracted from the left-eye video data is scanned on the right-eye video data, to obtain the position of a corresponding block, and the distance between the blocks is determined as the shift amount (offset). The offset is obtained for each pixel or each block. Hereinafter, the offset calculated by the video offset calculation unit 204 is referred to as a video offset.

The L graphic decoder 206L generates left-eye graphic data by decoding, for each frame, coded left-eye graphic data included in the coded 3D image data 55.

The L graphic memory 207L is a memory in which the left-eye graphic data generated by the L graphic decoder 206L is stored for each frame.

The L image output control unit 208L outputs, at a predetermined frame rate, the left-eye graphic data stored in the L graphic memory 207L.

The R graphic decoder 206R generates right-eye graphic data by decoding, for each frame, coded right-eye graphic data included in the coded 3D image data 55.

The R graphic memory 207R is a memory in which the right-eye graphic data generated by the R graphic decoder 206R is stored for each frame.

The R image output control unit 208R outputs, at a predetermined frame rate, the right-eye graphic data stored in the R graphic memory 207R.

The graphic offset calculation unit 209 obtains, as an offset, a horizontal shift amount between the left-eye graphic data stored in the L graphic memory 207L and the right-eye graphic data stored in the R graphic memory 207R, based on such graphic data. The shift amount is calculated by pattern matching between the left-eye graphic data and the right-eye graphic data. For example, a block of a predetermined size (e.g., a block of 8×8 pixels) extracted from the left-eye graphic data is scanned on the right-eye graphic data, to obtain the position of a corresponding block, and the distance between the blocks is determined as the shift amount (offset). The offset is obtained for each pixel or each block. Hereinafter, the offset calculated by the graphic offset calculation unit 209 is referred to as a graphic offset.

The control unit 205 compares, for each pixel or each block, the video offset calculated by the video offset calculation unit 204 with the graphic offset calculated by the graphic offset calculation unit 209.

On the basis of the comparison result in the control unit 205, the L synthesis unit 162L superimposes the left-eye graphic data output by the L image output control unit 208L, on the left-eye video data output by the L image output control unit 203L, and outputs the resultant data as the left-eye image 58L. That is, the L synthesis unit 162L superimposes the left-eye graphic data only for a pixel or block in which the graphic offset is greater than the video offset.

Likewise, on the basis of the comparison result in the control unit 205, the R synthesis unit 162R superimposes the right-eye graphic data output by the R image output control unit 208R, on the right-eye video data output by the R image output control unit 203R, and outputs the resultant data as the right-eye image 58R. That is, the R synthesis unit 162R superimposes the right-eye graphic data only for a pixel or block in which the graphic offset is greater than the video offset.

In the L synthesis unit 162L and the R synthesis unit 162R, no transparency process is performed in the superimposing. Specifically, as in the variation of the first embodiment, the blend ratio of the left-eye graphic data or the right-eye graphic data is 100% and the blend ratio of the left-eye video data or the right-eye video data is 0%, in superimposing the data.

The selector 180 is connected to the L synthesis unit 162L and the R synthesis unit 162R, and selects one of the left-eye image 58L and the right-eye image 58R according to a control signal from the L/R switch control unit 170, and then outputs the selected image. The L/R switch control unit 170 generates the control signal such that the selector 180 outputs the left-eye image 58L and the right-eye image 58R alternately at a predetermined frame rate, and then outputs the generated control signal to the selector 180. Through the processing of the L/R switch control unit 170 and the selector 180, the selector 180 generates the output 3D image data 58 in which the left-eye image 58L and the right-eye image 58R are alternately disposed.

Next, a process which the 3D image processing apparatus 100 executes is described with a specific example.

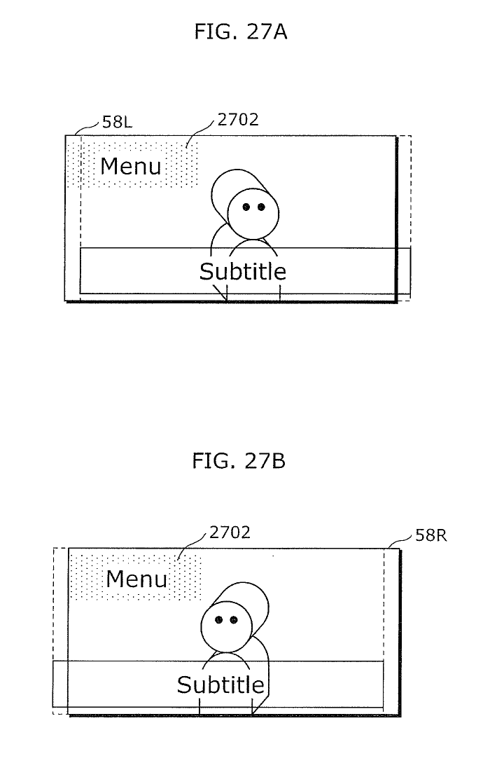

FIGS. 27A and 27B each show an example of the output 3D image data 58 in which the graphic offset of a subtitle is greater than the video offset. FIG. 27A shows an example of the left-eye image 58L and FIG. 27B shows an example of the right-eye image 58R.

The graphic data includes subtitle data 2701 and menu data 2702. FIGS. 27A and 27B show the left-eye image 58L and the right-eye image 58R, respectively, using rectangles of solid lines, and other areas than the rectangles will not be displayed on the display panel 26. Since the graphic offset of the subtitle data 2701 is greater than the video offset, the L synthesis unit 162L and the R synthesis unit 162R generate the left-eye image 58L and the right-eye image 58R, respectively, by superimposing the subtitle data 2701 on the left-eye video data and the right-eye video data. In the 3D presentation of the left-eye image 58L and the right-eye image 58R, the subtitle data 2701 is displayed in front. Thus, it is possible to generate image signals of images which bring no feeling of strangeness to viewers.

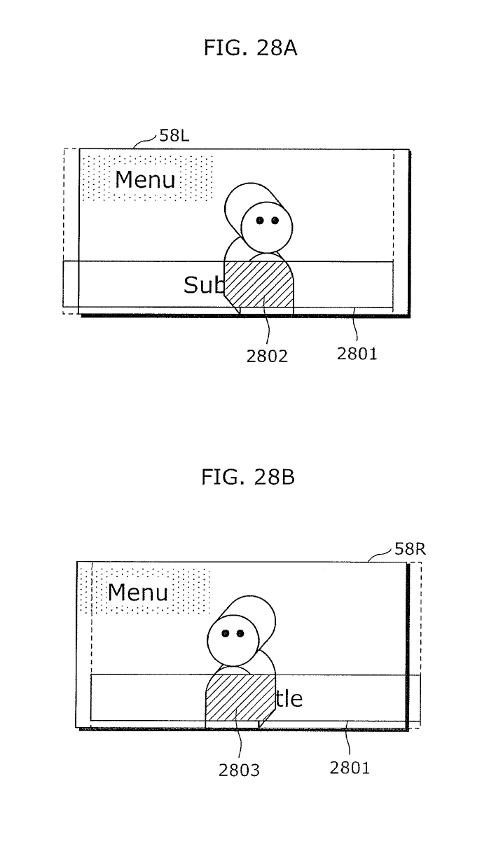

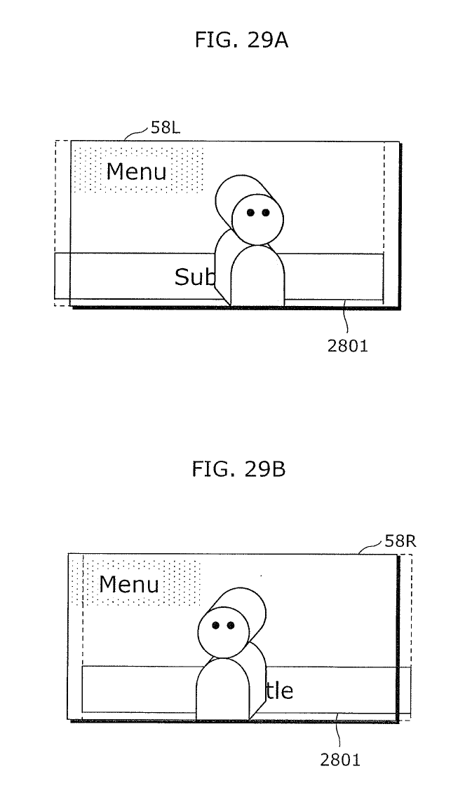

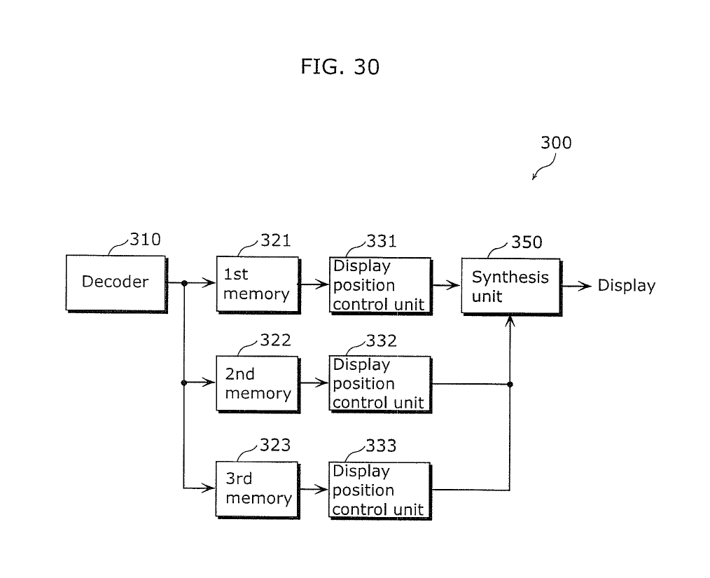

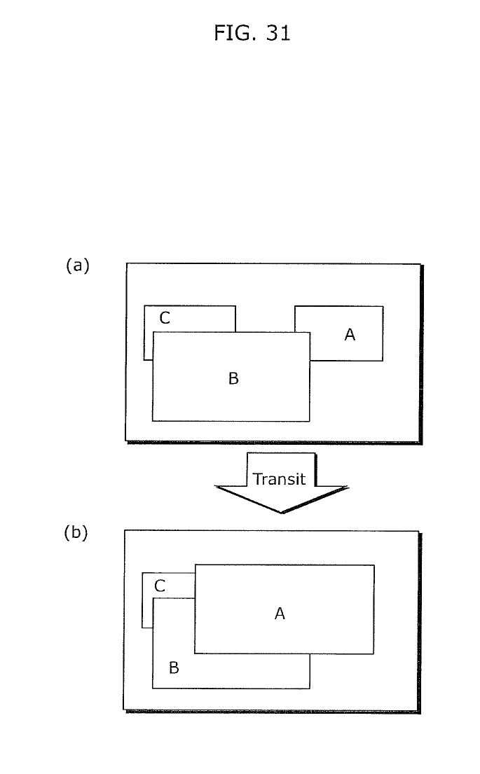

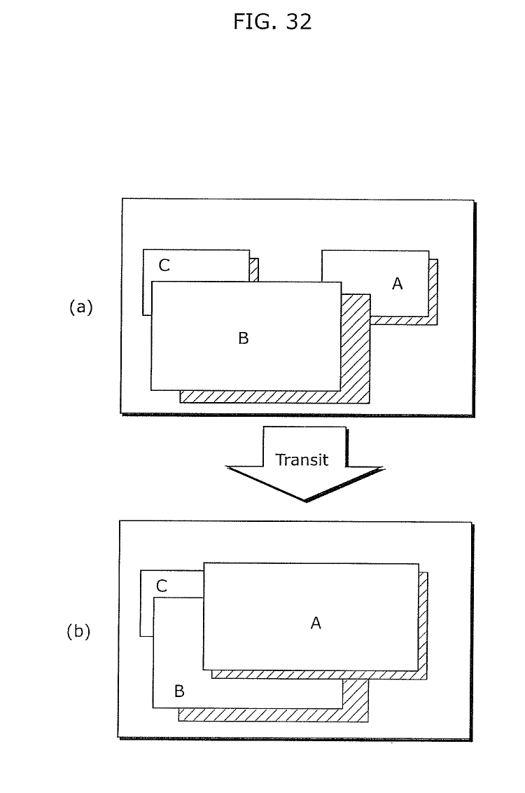

FIGS. 28A and 28B and FIGS. 29A and 29B explain a process to be executed in the case where the graphic offset of the subtitle is smaller than the video offset.

FIGS. 28A and 28B each show a region where the graphic offset of the subtitle data is smaller than the video offset.

FIG. 28A shows a region 2802 of the left-eye image 58L with cross-hatching, in which the graphic offset of subtitle data 2801 is smaller than the video offset. Likewise, FIG. 28B shows a region 2803 of the right-eye image 58R with cross-hatching, in which the graphic offset of subtitle data 2801 is smaller than the video offset. That is, the regions 2802 and 2803 are regions in which the video data is located forward of the subtitle data 2801 in 3D presentation.

FIGS. 29A and 29B each show an example of the output 3D image data 58 in which the graphic offset of a subtitle is smaller than the video offset. FIG. 29A shows an example of the right-eye image 58L and FIG. 29B shows an example of the right-eye image 58R.

As shown in FIG. 29A, the L synthesis unit 162L does not superimpose the subtitle data 2801 on the graphic data in the region 2802. This results in the left-eye image 58L in which the pixel values in the region 2802 are the pixel value of the video data.

Likewise, as shown in FIG. 29B, the R synthesis unit 162R does not superimpose the subtitle data 2801 on the graphic data in the region 2803. This results in the right-eye image 58R in which the pixel values in the region 2803 are the pixel value of the video data.

Consequently, in the 3D presentation of the left-eye image 58L and the right-eye image 58R, the video data is displayed in front in the regions 2802 and 2803. Thus, it is possible to generate image signals of images which bring no feeling of strangeness to viewers.

While the above describes the 3D image processing apparatuses according to the embodiments of the present invention, the present invention is not limited to these embodiments.

For example, the above embodiments assume that the right-eye image and the left-eye image which have a parallax therebetween are presented to display images which convey a stereoscopic perception to viewers. However, the number of image views is not limited to two and may be three or more. Specifically, the 3D image processing apparatus may be a 3D image processing apparatus which generates image signals of multiple views for stereoscopic vision, the 3D image processing apparatus including: a blend ratio determination unit configured to determine, for each of a plurality of objects which are displayed in layers, a blend ratio that is used in synthesizing images, at each pixel position of the image signals of the views, based on an offset that is an amount of shift in position between the image signals of the views of the object; and a synthesis unit configured to synthesize, based on the blend ratio determined by the blend ratio determination unit, pixel values of the objects at the each pixel position of the image signals of the views, to generate the image signals of the views.

The thumbnail may be a thumbnail of video instead of the thumbnail of a photograph. In this case, the thumbnail of video has an offset which is different in each pixel, and the offset changes for each frame. Thus, there is a case where the offset of rear position thumbnail is greater than the offset of front position thumbnail in the region where the thumbnails overlap. In such a case, in order to prevent a part of the region of the rear position thumbnail from being displayed forward of the front position thumbnail, the offset of the rear position thumbnail may be updated to the same value as the offset of the front position thumbnail when the offset of the rear position thumbnail is greater than the offset of the front position thumbnail. By so doing, a part of the region of the rear position thumbnail will be no longer displayed forward of the front position thumbnail, and it is therefore possible to generate image signals of images which bring no feeling of strangeness to viewers.

Furthermore, while the blend ratio is determined by linking it with an offset after determination of the offset in the above description, it may be such that the offset is determined by linking it with a blend ratio after determination of the blend ratio.

Furthermore, while the blend ratio is selected from among the predetermined fixed blend ratios in the above description, the blend ratio may be determined by linking it with the offset. That is, the blend ratio may be determined by multiplying the offset by a predetermined coefficient.

Furthermore, while the above description illustrates an example where a pair of dedicated glasses (the shutter glasses 43) is used, the present invention is applicable also to a system capable of providing 3D presentation using no dedicated glasses.

Furthermore, while the above description illustrates an example where the 3D image includes the left-eye images and the right-eye images which have different parallaxes, the 3D image may include three or more images which have different parallaxes.

Furthermore, while the 3D image processing apparatus 100 outputs the left-eye image 58L and the right-eye image 58R separately in the above description, the left-eye image 58L and the right-eye image 58R may be synthesized before output.

Furthermore, while the above description illustrates an example where the 3D image processing apparatus 100 according to the implementations of the present invention is applied to a digital television and a digital video recorder, the 3D image processing apparatus 100 according to the implementations of the present invention may be applied to 3D image display devices (such as mobile phone devices and personal computers) other than the digital television, which display 3D images. Furthermore, the 3D image processing apparatus 100 according to the implementations of the present invention is applicable to 3D image output devices (such as BD players) other than the digital video recorder, which output 3D images.

Furthermore, the above 3D image processing apparatus 100 according to the first to third embodiments is typically implemented as a large-scale integration (LSI) that is an integrated circuit. Components may be each formed into a single chip, and it is also possible to integrate part or all of the components in a single chip.

This circuit integration is not limited to the LSI and may be achieved by providing a dedicated circuit or using a general-purpose processor. It is also possible to utilize a field programmable gate array (FPGA), with which LSI is programmable after manufacture, or a reconfigurable processor, with which connections, settings, etc., of circuit cells in LSI are reconfigurable.

Furthermore, if any other circuit integration technology to replace LSI emerges thanks to semiconductor technology development or other derivative technology, such technology may, of course, be used to integrate the processing units.

Moreover, the processor such as CPU may execute a program to perform part or all of the functions of the 3D image processing apparatuses 100 and 100B according to the first to third embodiments of the present invention.

Furthermore, the present invention may be the above program or a recording medium on which the above program has been recorded. It goes without saying that the above program may be distributed via a communication network such as the Internet.

Furthermore, it may also be possible to combine at least part of functions of the above-described 3D image processing apparatuses 100 and 100B according to the first to third embodiments and variations thereof.

All the numerical values herein are given as examples to provide specific explanations of the present invention, and the present invention is thus not restricted by those numerical values.

Furthermore, the present invention encompasses various embodiments that are obtained by making various modifications which those skilled in the art could think of, to the present embodiments, without departing from the spirit or scope of the present invention.

The embodiments disclosed herein shall be considered in all aspects as illustrative and not restrictive. The scope of the present invention is indicated by the appended claims rather than the foregoing description and intended to cover all modifications within the scope of the claims and their equivalents.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to 3D image processing apparatuses and particularly to digital televisions, digital video recorders, and personal computers that generate image signals which can be displayed in 3D.

What is claimed is:

1. A three-dimensional (3D) image processing apparatus which generates image signals of multiple views for stereoscopic vision, said 3D image processing apparatus comprising:
a blend ratio determination unit configured to determine, for each of a plurality of objects which are displayed in layers, a blend ratio that is used in synthesizing images, at each pixel position of the image signals of the views, based on an offset that is an amount of shift in position between the image signals of the views of the object; and
a synthesis unit configured to synthesize, based on the blend ratio determined by said blend ratio determination unit, pixel values of the objects at the each pixel position of the image signals of the views, to generate the image signals of the views.

2. The 3D image processing apparatus according to claim 1,
wherein the image signals of the multiple views include a left-eye image signal and a right-eye image signal for stereoscopic vision,
said blend ratio determination unit is configured to determine, for each of the objects which are displayed in layers, the blend ratio that is used in synthesizing the images, at each pixel position of the left-eye image signal and the right-eye image signal, based on an offset that is an amount of shift in position between a left-eye image and a right-eye image of the object, and
said synthesis unit is configured to synthesize, based on the blend ratio determined by said blend ratio determination unit, the pixel values of the objects at the each pixel position of the left-eye image signal and the right-eye image signal, to generate the left-eye image signal and the right-eye image signal.

3. The 3D image processing apparatus according to claim 2,
wherein said blend ratio determination unit is configured to determine, for each of the objects which are displayed in layers, the blend ratio that is used in synthesizing the images, at the each pixel position of the left-eye image signal and the right-eye image signal, so that the blend ratio increases as the offset that is the amount of shift in position between the left-eye image and the right-eye image of the object increases.

4. The 3D image processing apparatus according to claim 3,
wherein said blend ratio determination unit is configured to determine the blend ratio at the each pixel position of the left-eye image signal and the right-eye image signal so that, among the objects which are displayed in layers, an object whose offset is largest has a blend ratio of 100 percent and an other object has a blend ratio of 0 percent.

5. The 3D image processing apparatus according to claim 4,
wherein the objects include a subtitle object.

6. The 3D image processing apparatus according to claim 3, said 3D image processing apparatus further comprising
an offset control unit configured to determine the offset of each of the objects based on a depth of the object in 3D presentation,
wherein said blend ratio determination unit is configured to determine the blend ratio based on the offset determined by said offset control unit.

7. The 3D image processing apparatus according to claim 6,
wherein said offset control unit is configured to determine the offset so that, among the objects, an object displayed forward in 3D presentation has a larger offset.

8. The 3D image processing apparatus according to claim 7,
wherein said offset control unit includes a selection input receiving unit configured to receive a selection input of the object, and is configured to determine the offset of the object received by said selection input receiving unit, so that the offset of the received object is largest.

9. The 3D image processing apparatus according to claim 7,
wherein said offset control unit is configured to increase the offset of a first object in stages when the first object transits from back to front with respect to a second object in 3D presentation.

10. The 3D image processing apparatus according to claim 3, further comprising
a limiting unit configured to limit a display region of the object so that the display region of the object is within a displayable region of the left-eye image signal or the right-eye image signal, when the display region of the object is located outside the displayable region.

11. The 3D image processing apparatus according to claim 10,
wherein said limiting unit is configured to, when the display region of the object is located outside the displayable region of one of the left-eye image signal and the right-eye image signal, (i) move the display region of the object on the one image signal so that the display region of the object is within the displayable region of the one image signal, and (ii) move, on the other image signal, the display region of the object in a direction opposite to a direction in which the display region of the object is moved on the one image signal, by a travel distance equal to a travel distance by which the display region of the object is moved on the one image signal.

12. The 3D image processing apparatus according to claim 11,
wherein said limiting unit is further configured to update the offset of the object whose display region is moved, to a value smaller than a current value.

13. The 3D image processing apparatus according to claim 10,
wherein said limiting unit is configured to delete, from the left-eye image signal and the right-eye image signal, a region of the object located outside the displayable region of the left-eye image signal or the right-eye image signal, when the display region of the object is located outside the displayable region.

14. The 3D image processing apparatus according to claim 3,
wherein the objects include a plurality of video objects each having the offset, and
when the offset of one of the video objects is larger than the offset of the object which is displayed forward of the video object in 3D presentation, the offset of the video object is updated to the offset of the object which is displayed forward.

15. A method of controlling a three-dimensional (3D) image processing apparatus which generates a left-eye image signal and a right-eye image signal for stereoscopic vision, said method comprising
determining, by a blend ratio determination unit, for each of a plurality of objects which are displayed in layers, a blend ratio that is used in synthesizing images, at each pixel position of the left-eye image signal and the right-eye image signal, so that the blend ratio increases as an offset that is an amount of shift in position between a left-eye image and a right-eye image of the object increases; and
synthesizing, by a synthesis unit, pixel values of the objects at the each pixel position of the left-eye image signal and the right-eye image signal, based on the blend ratio determined in said determining, to generate the left-eye image signal and the right-eye image signal.
